(19) United States
(12) Patent Application Publication
(10) Pub. No.: US 2026/0302823 A1
(43) Pub. Date: Oct. 1, 2026

(54) CHARGE AND DISCHARGE CONTROL CIRCUIT FOR CONTROLLING CHARGING AND DISCHARGING OF BATTERY

(71) Applicant: NISSHINBO MICRO DEVICES INC., Tokyo (JP)

(72) Inventor: Takayasu Yoshikawa, Tokyo (JP)

(21) Appl. No.: 19/557,611

(22) Filed: Mar. 5, 2026

(30) Foreign Application Priority Data
Mar. 31, 2025 (JP) 2025-057791

(51) Int. Cl. H02J 7/90; H01M 10/42; H01M 10/44; H01M 10/46; H02J 7/60; H02J 7/61; H02J 7/63

(52) U.S. Cl. CPC H02J 7/933; H01M 10/425; H01M 10/44; H01M 10/46; H02J 7/61; H02J 7/63; H02J 7/663; H02J 7/685

(57) ABSTRACT

A charge and discharge control circuit for preventing malfunction when a switch that controls charging and discharging of a secondary battery is turned on or off, includes an anomaly detection circuit detecting a charging or discharging prohibition anomaly state to generate an anomaly detection signal, and detecting resolution of the anomaly state to stop generation of the anomaly detection signal; a control circuit generating a switch control signal having a first or second value for turning off or on the switch based on the anomaly detection signal; and a state transition detection circuit generating a first count request signal based on the switch control signal and stopping generation of the first count request signal after a first time interval from occurrence of the first count request signal, wherein, during generation of the first count request signal, the control circuit holds the switch control signal for the first count request signal.

### CROSS REFERENCE TO RELATED APPLICATION

This application claims benefit of priority to Japanese Patent Application 2025-57791, filed Mar. 31, 2025, the entire content of which is incorporated herein by reference.

### BACKGROUND

### Technical Field

The present disclosure relates to a charge and discharge control circuit for controlling charging and discharging of a battery such as a secondary battery, a charge and discharge control method, and a battery device.

### Background Art

In general, a battery device for a secondary battery includes a secondary battery, a charge and discharge control circuit called a protection circuit, an external positive electrode terminal and an external negative electrode terminal used for charging and discharging the secondary battery, a charge control transistor that controls charging of the secondary battery, and a discharge control transistor that controls discharging of the secondary battery, The charge and discharge control circuit includes an external negative electrode voltage input terminal having an external negative electrode voltage corresponding to a voltage of the external negative electrode terminal. The charge and discharge control circuit is configured to detect various states by using a variation in the external negative electrode voltage. Therefore, in the charge and discharge control circuit, malfunction occurs due to an unintended variation in the external negative electrode voltage. To suppress such malfunction, for example, JP 7228719 B discloses a technique related to a charge and discharge control circuit capable of detecting connection of a charger even when a charger having a voltage lower than a predetermined value is connected while the charge and discharge control circuit of the battery device holds the discharge control transistor in an off state.

### SUMMARY

A conventional charge and discharge control circuit may erroneously detect anomaly of a battery device due to an operation of a switch that controls charging and discharging of a secondary battery, which may result in malfunction of a protection function for the secondary battery.

An object of the present disclosure is to provide a charge and discharge control circuit, a charge and discharge control method, and a battery device that suppress malfunction when a switch that controls charging and discharging of a secondary battery is turned on or off, as compared with the conventional technique.

A charge and discharge control circuit according to an aspect of the present disclosure is provided for preventing malfunction when a switch that controls charging and discharging of a secondary battery is turned on or off, the charge and discharge control circuit including: an anomaly detection circuit that detects a charging prohibition anomaly state or a discharging prohibition anomaly state to generate an anomaly detection signal, and detects resolution of the charging prohibition anomaly state or the discharging prohibition anomaly state to stop generation of the anomaly detection signal; a control circuit configured to generate a switch control signal having a first value for turning off the switch or the switch control signal having a second value for turning on the switch based on the anomaly detection signal; and a state transition detection circuit that generates a first count request signal based on a change in a value of the switch control signal and stops generation of the first count request signal after a predetermined first time interval from occurrence of the first count request signal, wherein, during the generation of the first count request signal, the control circuit holds the switch control signal to a value obtained on the occurrence of the first count request signal.

The present disclosure can provide a charge and discharge control circuit, a charge and discharge control method, and a battery device that suppress malfunction when a switch that controls charging and discharging of a secondary battery is turned on or off, as compared with the conventional technique.

### BRIEF DESCRIPTION OF DRAWINGS

FIG. 1 is a schematic diagram of a battery device according to a first embodiment;

FIG. 2 is a schematic diagram of a time measurement circuit according to the first embodiment;

FIG. 3 is a schematic diagram of a frequency divider circuit according to the first embodiment;

FIG. 4 is a timing chart illustrating an example of the operation of an oscillation circuit and the frequency divider circuit according to the first embodiment;

FIG. 5 is a schematic diagram illustrating an example of a time setting method for a time setting circuit according to the first embodiment;

FIG. 6 is a schematic diagram of a state transition detection circuit according to the first embodiment;

FIG. 7 is a schematic diagram of a discharge control driver and a charge control driver according to the first embodiment;

FIG. 8 is a flowchart illustrating an example of the operation of a charge and discharge control circuit according to the first embodiment;

FIG. 9 is a timing chart illustrating an example of the operation of the charge and discharge control circuit according to the first embodiment;

FIG. 10 is a timing chart illustrating an example of the operation of a charge and discharge control circuit according to a comparative example;

FIG. 11 is a schematic diagram of a battery device according to a second embodiment;

FIG. 12 is a schematic diagram of a time measurement circuit according to the second embodiment;

FIG. 13 is a schematic diagram of a state transition detection circuit according to the second embodiment;

FIG. 14 is a timing chart illustrating an example of the operation of the charge and discharge control circuit according to the second embodiment;

FIG. 15 is a schematic diagram of a time measurement circuit according to a modification; and

FIG. 16 is a schematic diagram of a battery device according to the modification.

### DETAILED DESCRIPTION

Hereinafter, embodiments according to the present disclosure will be described with reference to the drawings. The configuration described below is merely an example of the present disclosure, and the present disclosure is not limited to the following embodiments. The technique in the present disclosure is not limited thereto, and various changes, replacements, additions, omissions, and the like can be made according to designs and the like without departing from the technical idea according to the present disclosure even in a case other than these embodiments.

Although the present disclosure has been fully described in connection with preferred embodiments with reference to the accompanying drawings, various modifications and corrections will be apparent to those skilled in the art. Such modifications and corrections should be understood to be included within the scope of the present disclosure according to the appended claims as long as they do not depart from the scope of the present disclosure.

When a comparative example, a modification, or a plurality of embodiments are described in the present disclosure, points different from the first embodiment will be mainly described. In this case, in a comparative example, a modification, or another embodiment, the same or equivalent components as those of the first embodiment will be described with the same reference numerals. In a comparative example, a modification, or another embodiment, the description overlapping with the first embodiment may be omitted. The features described in modifications or embodiments may be combined with one another as long as there is no contradiction.

In general, a battery device for a secondary battery includes a secondary battery, a charge and discharge control circuit having a protection function for protecting the secondary battery, for example, at the time of charging and discharging, a discharge control transistor that controls discharging of the secondary battery, and a charge control transistor that controls charging of the secondary battery. The battery device includes an external positive electrode terminal and an external negative electrode terminal used for charging and discharging the secondary battery. The charge and discharge control circuit includes an external negative electrode voltage input terminal having an external negative electrode voltage corresponding to a voltage of the external negative electrode terminal. The charge and discharge control circuit is configured to monitor a state of the secondary battery, generate a control signal for switching on and off the discharge control transistor and the charge control transistor, respectively, and output the control signal to the discharge control driver and the charge control driver, thereby controlling charging and discharging of the secondary battery. The charge and discharge control circuit is configured to detect various states using variations in the external negative electrode voltage. Thus, malfunction of the charge and discharge control circuit may occur when an unintended variation of the external negative electrode voltage occurs. In addition to the variation of the external negative electrode voltage, malfunction of the charge and discharge control circuit may occur due to erroneous detection of an abnormal state. When such malfunction occurs at the time of occurrence of an abnormal state, the protection function that should originally operate in the abnormal state does not operate, and the battery device may be damaged.

A charge and discharge control circuit according to the present disclosure is a charge and discharge control circuit for preventing malfunction when a switch that controls charging and discharging of a secondary battery is turned on or off. The charge and discharge control circuit includes an anomaly detection circuit that detects an anomaly to generate an anomaly detection signal, a control circuit configured to generate a switch control signal for controlling a switch for charging and discharging the secondary battery, and a state transition detection circuit that detects a change in the value of the switch control signal. The anomaly detection circuit detects a charging prohibition anomaly state or a discharging prohibition anomaly state to generate an anomaly detection signal, and detects resolution of the charging prohibition anomaly state or the discharging prohibition anomaly state to stop generation of the anomaly detection signal. The control circuit generates a switch control signal having a first value for turning off the switch or a switch control signal having a second value for turning on the switch based on the anomaly detection signal. The state transition detection circuit generates a first count request signal based on a change in the value of the switch control signal, and stops generation of the first count request signal after a predetermined first time interval from occurrence of the first count request signal. During the generation of the first count request signal, the control circuit holds the switch control signal to the value obtained on the occurrence of the first count request signal. According to the configuration, for example, even though the anomaly detection circuit erroneously detects the charging prohibition anomaly state or the discharging prohibition anomaly state based on the change in the value of the switch control signal and generates the anomaly detection signal, the control circuit does not change the value of the switch control signal based on the anomaly detection signal. Thus, the charge and discharge control circuit according to the present disclosure can suppress malfunction that may occur when the switch that controls charging and discharging of the secondary battery is turned on or off. In addition, the charge and discharge control circuit according to the present disclosure can predetermine the first time interval in which the control circuit does not change the value of the switch control signal based on the anomaly detection signal. Thus, because the time required to prohibit the variation of the value of the switch control signal can be set in consideration of the component configuration and the parameter of the circuit element of the device to which the charge and discharge control circuit is attached, the charge and discharge control circuit according to the present disclosure can appropriately protect the battery device as compared with the conventional technique.

### First Embodiment

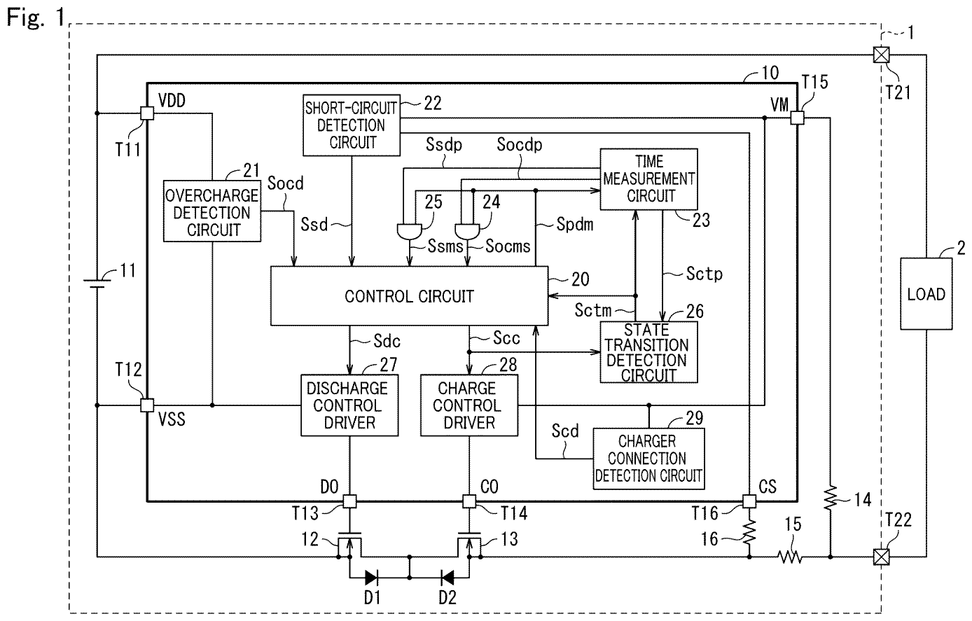

A battery device 1 according to a first embodiment of the present disclosure will be described with reference to FIG. 1. FIG. 1 is a schematic diagram of the battery device 1 according to the first embodiment of the present disclosure.

The battery device 1 includes a charge and discharge control circuit 10, a secondary battery 11, a discharge control transistor 12, a charge control transistor 13, and an external positive electrode terminal T21 and an external negative electrode terminal T22 to which a load 2 is connected. The battery device 1 includes resistors 14 to 16. In the first embodiment, the discharge control transistor 12 and the charge control transistor 13 are N-type MOS transistors. Each of the discharge control transistor 12 and the charge control transistor 13 is an example of a switch. The discharge control transistor 12 is an example of a second switch, and the charge control transistor 13 is an example of a first switch. The discharge control transistor 12 and the charge control transistor 13 may be another switch such as a bipolar transistor such as an insulated gate bipolar transistor (IGBT). Similarly, each MOS transistor described later may be another switch such as a bipolar transistor.

The external positive electrode terminal T21 is connected to the external negative electrode terminal T22 via the load 2. The load 2 includes at least one of a resistive load or a capacitive load. The resistive load refers to a device driven by a battery, for example, a CPU or a motor. The capacitive load refers to a capacitor capacitance, a capacitance obtained by summing all the parasitic capacitances of wiring or the like. The load 2 may include a charger that charges the secondary battery.

The charge and discharge control circuit 10 includes a control circuit 20, an overcharge detection circuit 21, a short-circuit detection circuit 22, a time measurement circuit 23, AND circuits 24 and 25, a state transition detection circuit 26, a discharge control driver 27, a charge control driver 28, and a charger connection detection circuit 29. The charge and discharge control circuit 10 also includes a positive electrode power supply terminal T11, a negative electrode power supply terminal T12, a discharge control terminal T13, a charge control terminal T14, an external negative electrode voltage input terminal T15, and a current detection terminal T16.

The source of the discharge control transistor 12 is connected to the negative electrode of the secondary battery 11 and grounded. The drain of the discharge control transistor 12 is connected to the drain of the charge control transistor 13. The gate of the discharge control transistor 12 is connected to the discharge control driver 27 via the discharge control terminal T13. A discharge control voltage DO is input from the discharge control driver 27 to the gate. The source of the charge control transistor 13 is connected to the external negative electrode terminal T22 via the resistor 15. The gate of the charge control transistor 13 is connected to the charge control driver 28 via the charge control terminal T14. A charge control voltage CO is input from the charge control driver 28 to the gate. The discharge control transistor 12 includes a parasitic diode DI, and the charge control transistor 13 includes a parasitic diode D2. The discharge control transistor 12 is turned on and off by the discharge control voltage DO applied to its gate from the discharge control driver 27. The charge control transistor 13 is turned on and off by the charge control voltage CO applied to its gate from the charge control driver 28.

The positive electrode power supply terminal T11 is connected to the positive electrode of the secondary battery 11 and the external positive electrode terminal T21. The negative electrode power supply terminal T12 is connected to the negative electrode of the secondary battery 11. The external negative electrode voltage input terminal T15 is connected to the external negative electrode terminal T22 and one end of the resistor 15 via the resistor 14. The external negative electrode voltage input terminal T15 has an external negative electrode voltage VM corresponding to the voltage of the external negative electrode terminal T22. The current detection terminal T16 is connected to the other end of the resistor 15 via the resistor 16. The negative electrode power supply voltage VSS of the negative electrode power supply terminal T12 is input to each circuit of the charge and discharge control circuit 10, but the illustration of the connection is omitted in each block diagram after FIG. 1 except for some circuits. The external negative electrode voltage input terminal TIS is an example of an external voltage detection terminal.

The charge and discharge control circuit 10 has one or more protection modes for controlling at least one of the discharge control transistor 12 or the charge control transistor 13 to be in a predetermined state based on an anomaly detection signal from an anomaly detection circuit such as the overcharge detection circuit 21 or the short-circuit detection circuit 22. The charge and discharge control circuit 10 switches from, for example, a normal mode to a mode such as a predetermined protection mode different from the normal mode based on an anomaly detection signal having a high level. In this manner, the charge and discharge control circuit 10 according to the first embodiment can perform at least protection against overcharge and protection against a short circuit as protection against anomalies. The charge and discharge control circuit 10 switches from a predetermined protection mode to, for example, the normal mode based on an anomaly detection signal having a low level. In addition, the charge and discharge control circuit 10 switches from the predetermined protection mode to, for example, the normal mode based on a detection signal related to a condition for recovery from the predetermined protection mode, such as a charger connection detection signal Scd having a high level to be described later. The detection signal related to the condition for recovery is generated, for example, based on comparison between the external negative electrode voltage VM and a predetermined threshold in a predetermined detection circuit. In this manner, the charge and discharge control circuit 10 according to the first embodiment can recover from the protection mode against overcharge and short circuit based on a predetermined signal.

The control circuit 20 generates a discharge control signal Sdc and a charge control signal Scc for controlling each of the discharge control transistor 12 and the charge control transistor 13 to a predetermined state based on an anomaly detection signal from an anomaly detection circuit such as the overcharge detection circuit 21 or the short-circuit detection circuit 22. The control circuit 20 includes a predetermined circuit element and a logic circuit. The control circuit 20 may be configured to include a processor such as a CPU and a storage device which is a storage medium for storing an arithmetic program, data, and the like.

For example, the charge and discharge control circuit 10 transitions from, for example, the normal mode to an overcharge protection mode after a predetermined delay time T1 based on an overcharge detection signal Socd having a high level. The control circuit 20 generates the charge control signal Scc having a low level based on the overcharge detection signal Socd having a high level from the overcharge detection circuit 21, and outputs the charge control signal Scc to the charge control driver 28 and the state transition detection circuit 26. The charge control driver 28 turns off the charge control transistor 13 based on the charge control signal Scc. Then, the control circuit 20 controls the charge control signal Scc to maintain the charge control transistor 13 in an off state during the overcharge protection mode. The charge and discharge control circuit 10 transitions from the overcharge protection mode to, for example, the normal mode after a predetermined delay time based on the overcharge detection signal Socd having a low level. The control circuit 20 generates the charge control signal Scc having a high level based on the overcharge detection signal Socd having a low level from the overcharge detection circuit 21, turns on the charge control transistor 13 via the charge control driver 28, and controls the charge control signal Scc to maintain the charge control transistor 13 in an on state during the normal mode.

In this manner, when the condition for recovery from the predetermined protection mode is satisfied, the charge and discharge control circuit 10 cancels the protection mode and transitions to another mode such as the normal mode. The delay time T1 may be the same as or different from the delay time upon recovery from the overcharge protection mode. The charge control signal Scc is an example of a switch control signal. The low level of the charge control signal Scc is an example of the first value. The high level of the charge control signal Scc is an example of a second value. The delay time T1 is an example of a second time interval. The delay time upon recovery from the overcharge protection mode is an example of a third time interval.

For example, the charge and discharge control circuit 10 transitions from, for example, the normal mode to the short-circuit protection mode after a predetermined delay time T3 based on a short-circuit detection signal Ssd having a high level. The control circuit 20 generates the discharge control signal Sdc having a low level based on the short-circuit detection signal Ssd having a high level from the short-circuit detection circuit 22, and outputs the discharge control signal Sdc to discharge control driver 27. The discharge control driver 27 turns off the discharge control transistor 12 based on the discharge control signal Sdc. Then, the control circuit 20 controls the discharge control signal Sdc to maintain the discharge control transistor 12 in an off state during the short-circuit protection mode. The charge and discharge control circuit 10 transitions from the short-circuit protection mode to, for example, the normal mode after a predetermined delay time based on the charger connection detection signal Scd having a high level. The control circuit 20 generates the discharge control signal Sdc having a high level based on the charger connection detection signal Scd having a high level from the charger connection detection circuit 29, turns on the discharge control transistor 12 via the discharge control driver 27, and controls the discharge control signal Sdc to maintain the discharge control transistor 12 in an on state during the normal mode.

The delay time T3 may be the same as or different from the delay time upon recovery from the short-circuit protection mode. The delay time T3 is an example of a fourth time interval. The delay time upon recovery from the short-circuit protection mode based on the charger connection detection signal Scd is an example of a fifth time interval. The discharge control signal Sdc is an example of the switch control signal. The low level of the discharge control signal Sdc is an example of the first value. The high level of the discharge control signal Sdc is an example of the second value.

When receiving the anomaly detection signal having a high level, the control circuit 20 generates a protection delay time measurement request Spdm having a high level and outputs the protection delay time measurement request Spdm to the time measurement circuit 23, the AND circuit 24, and the AND circuit 25. The control circuit 20 receives a delay time elapse signal having a high level after a predetermined delay time from the occurrence of the request. The charge and discharge control circuit 10 switches from, for example, the normal mode to a predetermined protection mode based on the delay time elapse signal having a high level. The delay time lapse signal includes, for example, an overcharge delay time elapse signal Socdp and a short-circuit delay time elapse signal Ssdp described later. For example, when the short-circuit delay time elapse signal Ssdp having a high level is generated during generation of the protection delay time measurement request Spdm having a high level based on generation of the short-circuit detection signal Ssd, the charge and discharge control circuit 10 switches from the normal mode to the short-circuit protection mode. For example, when the overcharge delay time elapse signal Socdp having a high level is generated during generation of the protection delay time measurement request Spdm having a high level based on generation of the overcharge detection signal Socd, the charge and discharge control circuit 10 switches from the normal mode to the overcharge protection mode. The control circuit 20 generates the protection delay time measurement request Spdm having a low level based on the short-circuit delay time elapse signal Ssdp or the overcharge delay time elapse signal Socdp having a high level.

The protection delay time measurement request Spdm is an example of second to fifth count request signals. The control circuit 20 generating the protection delay time measurement request Spdm having a high level is an example of the control circuit 20 generating the second count request signal. The control circuit 20 generating the protection delay time measurement request Spdm having a low level is an example of the control circuit 20 stopping generation of the second count request signal.

When the control circuit 20 receives a charge control transition time measurement request Sctm having a high level to be described later, the charge and discharge control circuit 10 transitions from any operation mode to a charge control transition mode. In the charge control transition mode, the control circuit 20 operates so as not to change the levels of the charge control signal Sec and the discharge control signal Sdc even when receiving the anomaly detection signal. For example, the control circuit 20 prohibits generation of the protection delay time measurement request Spdm having a high level in the charge control transition mode. When the control circuit 20 receives the charge control transition time measurement request Sctm having a low level, the charge and discharge control circuit 10 transitions from the charge control transition mode to any operation mode. For example, the control circuit 20 lifts prohibition of generation of the protection delay time measurement request Spdm having a high level.

The overcharge detection circuit 21 receives a positive electrode power supply voltage VDD of the positive electrode power supply terminal T11 and a negative electrode power supply voltage VSS of the negative electrode power supply terminal T12. The overcharge detection circuit 21 generates the overcharge detection signal Socd based on the differential voltage between the positive electrode power supply voltage VDD and the negative electrode power supply voltage VSS, and outputs the overcharge detection signal Socd to the control circuit 20. When detecting that the differential voltage is equal to or greater than a predetermined overcharge detection voltage, the overcharge detection circuit 21 generates the overcharge detection signal Socd having a high level. When detecting that the differential voltage is less than a predetermined overcharge recovery voltage, the overcharge detection circuit 21 generates the overcharge detection signal Socd having a low level. The overcharge detection voltage may be, for example, 4.5 V. The delay time T1 may be, for example, 1 second.

The overcharge detection circuit 21 is an example of an anomaly detection circuit. The overcharge detection signal Socd is an example of the anomaly detection signal and a charging anomaly detection signal. The condition that the differential voltage between the positive electrode power supply voltage VDD and the negative electrode power supply voltage VSS is greater than or equal to a predetermined overcharge detection voltage is an example of the charging prohibition anomaly state. The condition that the differential voltage is less than the predetermined overcharge recovery voltage is an example of resolution of the charging prohibition anomaly state. The overcharge detection circuit 21 generating the overcharge detection signal Socd having a high level is an example of the overcharge detection circuit 21 generating the anomaly detection signal. The overcharge detection circuit 21 generating the overcharge detection signal Socd having a low level is an example of the overcharge detection circuit 21 stopping generation of the anomaly detection signal.

The short-circuit detection circuit 22 receives the external negative electrode voltage VM of the external negative electrode voltage input terminal T15 and the current detection voltage CS of the current detection terminal T16. The short-circuit detection circuit 22 generates the short-circuit detection signal Ssd based on the differential voltage between the external negative electrode voltage VM and the current detection voltage CS, and outputs the short-circuit detection signal Ssd to the control circuit 20. The short-circuit detection circuit 22 may be configured to detect an anomaly state for a short circuit based on another voltage. For example, the short-circuit detection circuit 22 may generate the short-circuit detection signal Ssd based on the differential voltage between the external negative electrode voltage VM and the negative electrode power supply voltage VSS. When detecting that the differential voltage is equal to or greater than a predetermined short-circuit detection voltage, the short-circuit detection circuit 22 generates the short-circuit detection signal Ssd having a high level. When detecting that the differential voltage is less than a predetermined short-circuit recovery voltage, the short-circuit detection circuit 22 generates the short-circuit detection signal Ssd having a low level. The short-circuit detection voltage may be, for example, 20 mV. The delay time T3 may be, for example, 0.25 ms.

The short-circuit detection circuit 22 is an example of the anomaly detection circuit. The short-circuit detection signal Ssd is an example of the anomaly detection signal and a discharging anomaly detection signal. The condition that the differential voltage between the external negative electrode voltage VM and the current detection voltage CS is greater than or equal to the predetermined short-circuit detection voltage is an example of the discharging prohibition anomaly state. The short-circuit detection circuit 22 generating the short-circuit detection signal Ssd having a high level is an example of the short-circuit detection circuit 22 generating the anomaly detection signal.

The charger connection detection circuit 29 receives the external negative electrode voltage VM. The charger connection detection circuit 29 compares the external negative electrode voltage VM with a predetermined charger connection detection threshold voltage. Then, when detecting that the external negative electrode voltage VM is pulled down to a voltage lower than the charger connection detection threshold voltage due to the connection of the charger, the charger connection detection circuit 29 generates, for example, the charger connection detection signal Scd having a high level after a predetermined delay time from the detection and outputs the charger connection detection signal Scd to the control circuit 20. Generation of the charger connection detection signal Scd having a high level is an example of generation of the charger connection detection signal by the charger connection detection circuit 29.

The time measurement circuit 23 generates the overcharge delay time elapse signal Socdp, the short-circuit delay time elapse signal Ssdp, and a charge control transition time elapse signal Sctp having predetermined levels, and outputs the signals to the AND circuit 24, the AND circuit 25, and the state transition detection circuit 26, respectively. Based on the protection delay time measurement request Spdm or the charge control transition time measurement request Sctm having a high level, the time measurement circuit 23 counts a predetermined time interval to generate time elapse signals Socdp, Ssdp, and Sctp having a high level. The time measurement circuit 23 generates the time elapse signals Socdp, Ssdp, and Sctp having a low level based on the protection delay time measurement request Spdm and the charge control transition time measurement request Sctm having a low level. The time measurement circuit 23 resets counting based on the protection delay time measurement request Spdm and the charge control transition time measurement request Sctm having a low level.

The overcharge delay time elapse signal Socdp is an example of a second time interval elapse signal. The charge control transition time elapse signal Sctp is an example of a first time interval elapse signal. The time measurement circuit 23 generating the overcharge delay time elapse signal Socdp or the short-circuit delay time elapse signal Ssdp having a high level is an example of the time measurement circuit 23 generating the second time interval elapse signal. The time measurement circuit 23 generating the overcharge delay time elapse signal Socdp or the short-circuit delay time elapse signal Ssdp having a low level is an example of the time measurement circuit 23 stopping generation of the second time interval elapse signal. The time measurement circuit 23 generating the charge control transition time elapse signal Sctp having a high level is an example of the time measurement circuit 23 generating the first time interval elapse signal. The time measurement circuit 23 generating the charge control transition time elapse signal Sctp having a low level is an example of the time measurement circuit 23 stopping generation of the first time interval elapse signal.

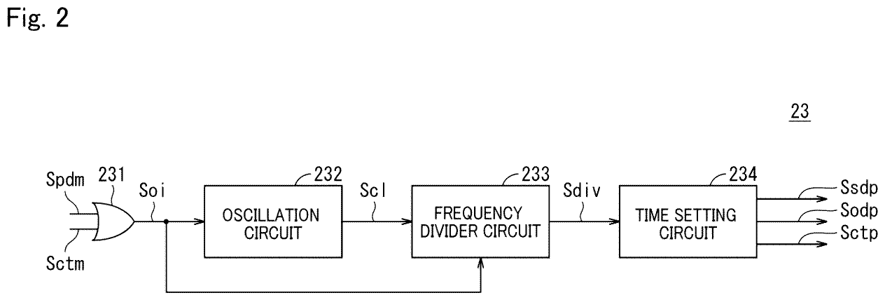

FIG. 2 is a schematic diagram of the time measurement circuit 23 according to the first embodiment. The time measurement circuit 23 according to the first embodiment includes an OR circuit 231, an oscillation circuit 232, a frequency divider circuit 233, and a time setting circuit 234.

The OR circuit 231 generates an oscillation instruction signal Soi having a predetermined level based on the input protection delay time measurement request Spdm and charge control transition time measurement request Sctm, and outputs the oscillation instruction signal Soi to the oscillation circuit 232 and the frequency divider circuit 233. When at least one of the protection delay time measurement request Spdm or the charge control transition time measurement request Sctm has a high level, the OR circuit 231 generates the oscillation instruction signal Soi having a high level. The OR circuit 231 generates the oscillation instruction signal Soi having a low level when both the protection delay time measurement request Spdm and the charge control transition time measurement request Sctm have a low level.

The oscillation circuit 232 generates a clock signal Scl based on the oscillation instruction signal Soi and outputs the clock signal Scl to the frequency divider circuit 233. When receiving the oscillation instruction signal Soi having a high level, the oscillation circuit 232 starts oscillation, and switches the clock signal Scl between a high level and a low level at a predetermined period Tcl such as 0.5 ms, for example. When receiving the oscillation instruction signal Soi having a low level, the oscillation circuit 232 stops the oscillation and generates the clock signal Scl having a low level.

The frequency divider circuit 233 generates a frequency-divided signal Sdiv based on the clock signal Scl and outputs the frequency-divided signal Sdiv to the time setting circuit 234. When receiving the oscillated clock signal Scl, the frequency divider circuit 233 generates n frequency-divided signals Sdiv obtained by dividing the period Tcl of the clock signal Scl to 2ⁿ⁻¹ times. n is a natural number. The n frequency-divided signals Sdiv include frequency-divided signals Sdiv1, Sdiv2, . . . , Sdivn. In the present specification, the n frequency-divided signals Sdiv1, Sdiv2, . . . , Sdivn may also be referred to as frequency-divided signals Sdiv. The frequency divider circuit 233 switches between a high level and a low level at a period that is 2ⁿ⁻¹ times the period Tcl of the clock signal Scl in each frequency-divided signal Sdivn (n is a natural number). The frequency divider circuit 233 is initialized when receiving the oscillation instruction signal Soi having a low level, and generates the frequency-divided signal Sdiv having a low level.

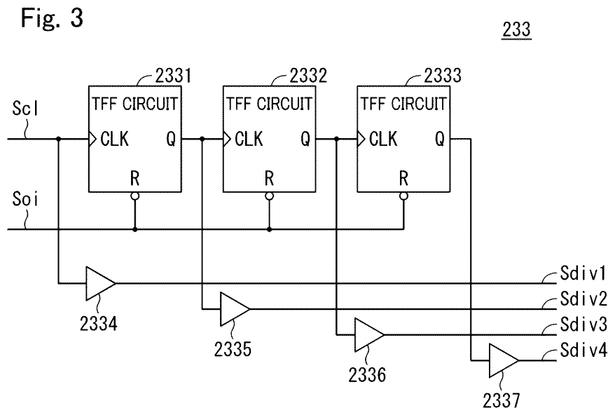

FIG. 3 is a schematic diagram of the frequency divider circuit 233 according to the first embodiment. As illustrated in FIG. 3, the frequency divider circuit 233 includes a plurality of toggle flip-flop (TFF) circuits 2331 to 2333 and a plurality of buffer circuits 2334 to 2337. The frequency divider circuit 233 illustrated in FIG. 3 illustrates an example in a case where n=4. n is not limited to 4, and any number such as 5, 10, and 20 may be set. The clock signal Scl from the oscillation circuit 232 is input to the terminal CLK of the TFF circuit 2331. The terminal Q of the TFF circuit 2331 is connected to the terminal CLK of the TFF circuit 2332. The terminal Q of the TFF circuit 2332 is connected to the terminal CLK of the TFF circuit 2333. A signal obtained by inverting the level of the oscillation instruction signal Soi from the OR circuit 231 is input to the terminal R of each of the TFF circuits 2331 to 2333. When receiving the oscillation instruction signal Soi having a low level, each of the TFF circuits 2331 to 2333 resets the level of the signal generated from the terminal Q to a predetermined level such as a low level.

The buffer circuits 2334 to 2337 buffer the input signal and generate signals having a level similar to that of the input signal. The buffer circuit 2334 receives the clock signal Scl from the oscillation circuit 232 and generates the frequency-divided signal Sdiv1 having a level similar to that of the clock signal Scl. The buffer circuit 2335 receives a signal from the terminal Q of the TFF circuit 2331 and generates the frequency-divided signal Sdiv2 having a level similar to that of the signal. The buffer circuit 2336 receives a signal from the terminal Q of the TFF circuit 2332 and generates a frequency-divided signal Sdiv3 having a level similar to that of the signal. The buffer circuit 2337 receives a signal from the terminal Q of the TFF circuit 2333 and generates a frequency-divided signal Sdiv4 having a level similar to that of the signal.

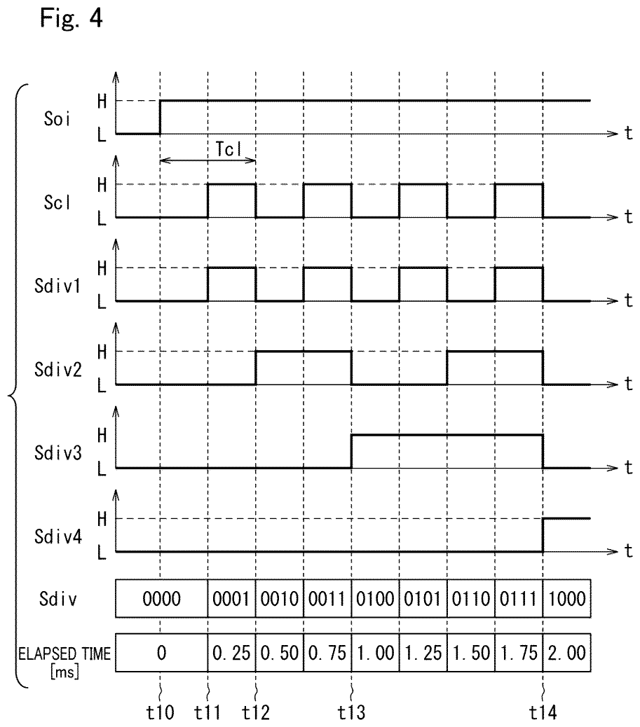

FIG. 4 is a timing chart illustrating an example of the operation of the oscillation circuit 232 and the frequency divider circuit 233 according to the first embodiment. The horizontal axis in FIG. 4 represents the time. The vertical axis in FIG. 4 indicates the level of the oscillation instruction signal Soi, the level of the clock signal Scl, and the level of each of the frequency-divided signals Sdiv1 to Sdiv4. Sdiv indicates the value in a case where the frequency-divided signal Sdiv indicated by each of the frequency-divided signals Sdiv1 to Sdiv4 is represented by four bits. The elapsed time indicates an example of an elapsed time [ms] represented by Sdiv.

Until the oscillation circuit 232 receives the oscillation instruction signal Soi having a high level, the frequency divider circuit 233 generates frequency-divided signals Sdiv1 to Sdiv4 having a low level. At time t10, when the OR circuit 231 generates the oscillation instruction signal Soi having a high level, the oscillation circuit 232 switches the clock signal Scl between the high level and the low level at the predetermined period Tcl based on the oscillation instruction signal Soi having a high level. At time t11, when receiving the clock signal Scl having a high level, the buffer circuit 2334 generates a frequency-divided signal Sdiv1 having a high level. At time t12, when the clock signal Scl changes from a high level to a low level, the buffer circuit 2334 generates the frequency-divided signal Sdiv1 having a low level. The TFF circuit 2331 generates a signal having a high level from the terminal Q, and the buffer circuit 2335 generates a frequency-divided signal Sdiv2 having a high level.

At time t13, when the clock signal Scl changes from a high level to a low level, the buffer circuit 2334 generates the frequency-divided signal Sdiv1 having a low level. The TFF circuit 2331 generates a signal having a low level from the terminal Q, and the buffer circuit 2335 generates the frequency-divided signal Sdiv2 having a low level. The TFF circuit 2332 generates a signal having a high level from the terminal Q, and the buffer circuit 2336 generates the frequency-divided signal Sdiv3 having a high level.

At time t14, when the clock signal Scl changes from a high level to a low level, the buffer circuit 2334 generates the frequency-divided signal Sdiv1 having a low level. The TFF circuit 2331 generates a signal having a low level from the terminal Q, and the buffer circuit 2335 generates the frequency-divided signal Sdiv2 having a low level. The TFF circuit 2332 generates a signal having a low level from the terminal Q, and the buffer circuit 2336 generates the frequency-divided signal Sdiv3 having a low level. The TFF circuit 2333 generates a signal having a high level from the terminal Q, and the buffer circuit 2337 generates the frequency-divided signal Sdiv4 having a high level. In this manner, the frequency divider circuit 233 generates the frequency-divided signals Sdiv1 to Sdiv4 having a predetermined level based on the oscillation of the clock signal Scl.

In the first embodiment, the frequency-divided signals Sdiv are signals that can be represented by four bits. In FIG. 4, the frequency-divided signals Sdiv are represented by 1 when each of the frequency-divided signals Sdiv1 to Sdiv4 has a high level, and are represented by 0 when each of the frequency-divided signals Sdiv1 to Sdiv4 has a low level. At time t11, the frequency-divided signal Sdiv1 has a high level, and the other signals have a low level. Thus, the frequency-divided signal Sdiv is represented by “0001” and indicates that 0.25 ms have elapsed. At time t12, the frequency-divided signal Sdiv2 has a high level, and the other signals have a low level. Thus, the frequency-divided signal Sdiv is represented by “0010” and indicates that 0.5 ms have elapsed. When the frequency-divided signal Sdiv1 and the frequency-divided signal Sdiv2 have a high level and the other signals have a low level, the frequency-divided signal Sdiv is represented by “0011” and indicates that 0.75 ms have elapsed. In this manner, the frequency-divided signals Sdiv can indicate a predetermined elapse time from generation of the protection delay time measurement request Spdm or the charge control transition time measurement request Sctm having a high level based on the frequency-divided signals Sdiv1 to Sdiv4 having a high level.

The time setting circuit 234 illustrated in FIG. 2 counts a predetermined time interval based on the frequency-divided signal Sdiv to generate the time elapse signals Socdp, Ssdp, and Sctp having a high level. The time setting circuit 234 can be configured to set any predetermined time interval for each time elapse signal by a circuit signal switching device such as laser trimming. For example, the time setting circuit 234 may be configured to include a plurality of trimming fuses. By cutting the plurality of fuses by the laser trimming device except for one fuse, the time setting circuit 234 can generate and output a predetermined signal when any set time interval elapses. The time setting circuit 234 is not limited to this configuration. For example, it may be configured such that the predetermined time interval is set by switching the connection of metal wiring in the production process of the time setting circuit 234.

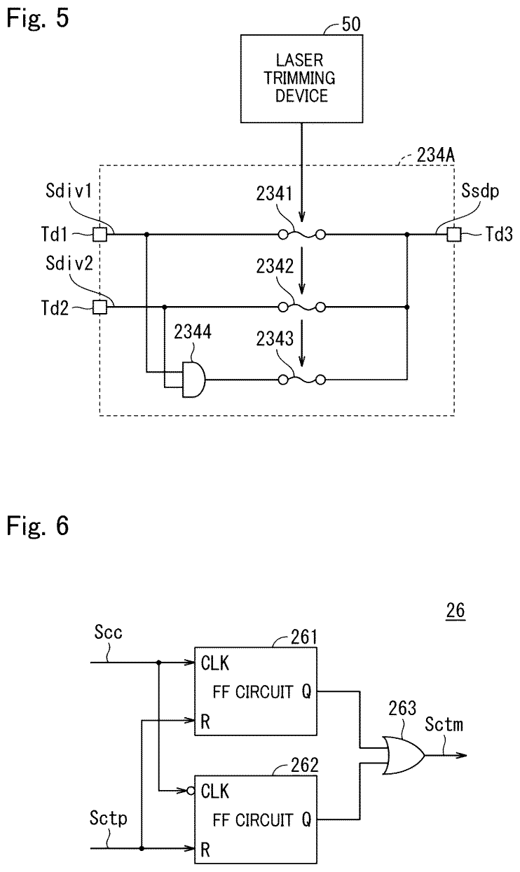

FIG. 5 is a schematic diagram illustrating an example of a time setting method for the time setting circuit 234 according to the first embodiment. FIG. 5 illustrates a first setting circuit 234A which is a part of the time setting circuit 234. The first setting circuit 234A is a circuit for counting the delay time T3 related to the short-circuit delay time elapse signal Ssdp. The first setting circuit 234A includes terminals Td1 to Td3, a plurality of fuses 2341 to 2343, and an AND circuit 2344. The fuse 2341 has one end connected to the terminal Td1 and the other end connected to the terminal Td3. The fuse 2342 has one end connected to the terminal Td2 and the other end connected to the terminal Td3. The fuse 2343 has one end connected to the output terminal of the AND circuit 2344 and the other end connected to the terminal Td3. The AND circuit 2344 includes a first input terminal connected to the terminal Td1, a second input terminal connected to the terminal Td2, and an output terminal that generates a signal having a predetermined level based on the signal to be input.

The frequency-divided signal Sdiv1 is input to the terminal Td1. The frequency-divided signal Sdiv2 is input to the terminal Td2. The terminal Td3 generates the short-circuit delay time elapse signal Ssdp having a predetermined level. The AND circuit 2344 generates a signal having a level representing the logical AND of the frequency-divided signal Sdiv1 and the frequency-divided signal Sdiv2 and outputs the signal to the fuse 2343.

In the first setting circuit 234A, two of the three fuses 2341 to 2343 are cut by the laser trimming device 50. The first setting circuit 234A generates the frequency-divided signal Sdiv input to the remaining fuse as the short-circuit delay time elapse signal Ssdp. For example, when the fuses 2342 and 2343 are cut, the delay time T3 is set as a time interval from the input of the protection delay time measurement request Spdm or the charge control transition time measurement request Sctm having a high level to generation of the frequency-divided signal Sdiv1 having a high level, that is, 0.25 ms. The first setting circuit 234A generates the short-circuit delay time elapse signal Ssdp having a high level 0.25 ms after the input of the protection delay time measurement request Spdm or the charge control transition time measurement request Sctm having a high level. For example, when the fuses 2341 and 2343 are cut, the delay time T3 is set to 0.5 ms. For example, when the fuses 2341 and 2342 are cut, the delay time T3 is set to 0.75 ms. In this manner, the time setting circuit 234 can generate a signal having a high level after a predetermined time interval from the input of the protection delay time measurement request Spdm or the charge control transition time measurement request Sctm for each time elapse signal.

The time setting circuit 234 further includes a second setting circuit related to the overcharge delay time elapse signal Socdp and a third setting circuit related to the charge control transition time elapse signal Sctp. Each of the second setting circuit and the third setting circuit may have a configuration different from that of the first setting circuit 234A. For example, the second setting circuit may be configured to include six fuses and three AND circuits and count the delay time T1 based on the frequency-divided signals Sdiv1 to Sdiv3. Similarly, the third setting circuit may be configured to count the predetermined time interval T2 by a plurality of fuses and a plurality of AND circuits. In this manner, the time setting circuit 234 includes a plurality of circuits that count the predetermined time interval, and can count each of the plurality of predetermined time intervals using each circuit. Thus, the delay time T1, the predetermined time interval T2, and the delay time T3 can be counted by the same time measurement circuit 23 that generates the overcharge delay time elapse signal Socdp, the charge control transition time elapse signal Sctp, and the short-circuit delay time elapse signal Ssdp different from each other.

The AND circuit 24 illustrated in FIG. 1 generates an overcharge delay time measurement stop request Socms having a level representing the logical AND of the protection delay time measurement request Spdm and the overcharge delay time elapse signal Socdp, and outputs the overcharge delay time measurement stop request Socms to the control circuit 20. Specifically, when the protection delay time measurement request Spdm having a high level and the overcharge delay time elapse signal Socdp having a high level are input, the AND circuit 24 generates the overcharge delay time measurement stop request Socms having a high level. Otherwise, the AND circuit 24 generates the overcharge delay time measurement stop request Socms having a low level. The control circuit 20 may be configured to receive the protection delay time measurement request Spdm and the overcharge delay time elapse signal Socdp without passing through the AND circuit 24 and operate based on the signals. Other AND circuits may be configured in the same manner.

The AND circuit 25 generates a short-circuit delay time measurement stop request Ssms having a level representing the logical AND of the protection delay time measurement request Spdm and the short-circuit delay time elapse signal Ssdp, and outputs the short-circuit delay time measurement stop request Ssms to the control circuit 20. Specifically, when the protection delay time measurement request Spdm having a high level and the short-circuit delay time elapse signal Ssdp having a high level are input, the AND circuit 25 generates the short-circuit delay time measurement stop request Ssms having a high level. Otherwise, the AND circuit 25 generates the short-circuit delay time measurement stop request Ssms having a low level. The control circuit 20 may be configured to receive the protection delay time measurement request Spdm and the short-circuit delay time elapse signal Ssdp without passing through the AND circuit 25, and operate based on the signals.

The state transition detection circuit 26 detects a transition of the state of the charge control transistor 13 based on the charge control signal Scc. For example, the state transition detection circuit 26 can detect that the charge control transistor 13 transitions from the OFF state to the ON state based on the charge control signal Scc having a high level. The state transition detection circuit 26 also can detect that the charge control transistor 13 transitions from the ON state to the OFF state based on the charge control signal Scc having a low level.

The state transition detection circuit 26 generates a charge control transition time measurement request Sctm based on the charge control signal Scc and outputs the charge control transition time measurement request Sctm to the control circuit 20 and the time measurement circuit 23. The state transition detection circuit 26 generates the charge control transition time measurement request Sctm having a high level based on a change in the level of the charge control signal Scc. The state transition detection circuit 26 generates the charge control transition time measurement request Sctm having a low level after the predetermined time interval T2 from occurrence of the charge control transition time measurement request Sctm having a high level. Specifically, when receiving the charge control transition time elapse signal Sctp having a high level after generation of the charge control transition time measurement request Sctm having a high level, the state transition detection circuit 26 generates the charge control transition time measurement request Sctm having a low level. The predetermined time interval T2 may be, for example, 1 ms. The predetermined time interval T2 is an example of the first time interval and a sixth time interval.

The charge control transition time measurement request Sctm is an example of the first count request signal. The state transition detection circuit 26 generating the charge control transition time measurement request Sctm having a high level is an example of the state transition detection circuit 26 generating the first count request signal. The state transition detection circuit 26 generating the charge control transition time measurement request Sctm having a low level is an example of that the state transition detection circuit 26 stopping generation of the first count request signal.

FIG. 6 is a schematic diagram of the state transition detection circuit 26 according to the first embodiment. The state transition detection circuit 26 includes flip-flop (FF) circuits 261 and 262 and an OR circuit 263. Each of the FF circuit 261 and the FF circuit 262 generates a signal based on both the charge control signal Scc and the charge control transition time elapse signal Sctp, and outputs the signal to the OR circuit 263.

The FF circuit 261 includes a terminal CLK to which the charge control signal Scc is input, a terminal R to which the charge control transition time elapse signal Sctp is input, and a terminal Q that generates a signal having a predetermined level based on the input signal. The FF circuit 262 includes a terminal CLK to which the inverted value of the charge control signal Scc is input, a terminal R to which the charge control transition time elapse signal Sctp is input, and a terminal Q that generates a signal having a predetermined level based on the input signal. When the charge control signal Scc changes from a low level to a high level, the FF circuit 261 latches and generates a signal having a high level from the terminal Q. When the charge control signal Scc changes from a high level to a low level, the FF circuit 262 latches and generates a signal having a high level from the terminal Q. When receiving the charge control transition time elapse signal Sctp having a high level, each of the FF circuit 261 and the FF circuit 262 releases the latch and generates a signal having a low level from the terminal Q.

The OR circuit 263 generates the charge control transition time measurement request Sctm having a level representing the logical OR of the signal from the FF circuit 261 and the signal from the FF circuit 262. That is, when at least one of the signals from the FF circuit 261 and from the FF circuit 262 has a high level, the OR circuit 263 generates the charge control transition time measurement request Sctm having a high level. The OR circuit 263 generates the charge control transition time measurement request Sctm having a low level when both the signal from the FF circuit 261 and the signal from the FF circuit 262 have a low level.

The discharge control driver 27 illustrated in FIG. 1 is configured to receive the negative electrode power supply voltage VSS and the discharge control signal Sdc from the control circuit 20. The discharge control driver 27 generates the discharge control voltage DO and outputs the discharge control voltage DO to the gate of the discharge control transistor 12. The discharge control driver 27 controls the discharge control voltage DO based on the discharge control signal Sdc to switch the discharge control transistor 12 on and off. For example, when receiving a high-level discharge control signal Sdc, the discharge control driver 27 generates the discharge control voltage DO having a high level so as to turn on the discharge control transistor 12. When receiving a low-level discharge control signal Sdc, the discharge control driver 27 generates the discharge control voltage DO having a low level so as to tum off the discharge control transistor 12.

The charge control driver 28 is configured to receive the external negative electrode voltage VM and the charge control signal Scc from the control circuit 20. The charge control driver 28 generates the charge control voltage CO and outputs the charge control voltage CO to the gate of the charge control transistor 13. The charge control driver 28 controls the charge control voltage CO based on the charge control signal Scc to switch the charge control transistor 13 on and off. For example, when receiving the high-level charge control signal Scc, the charge control driver 28 generates the charge control voltage CO having a high level so as to turn on the charge control transistor 13. When receiving the low-level charge control signal Scc, the charge control driver 28 generates the charge control voltage CO having a low level so as to turn off the charge control transistor 13.

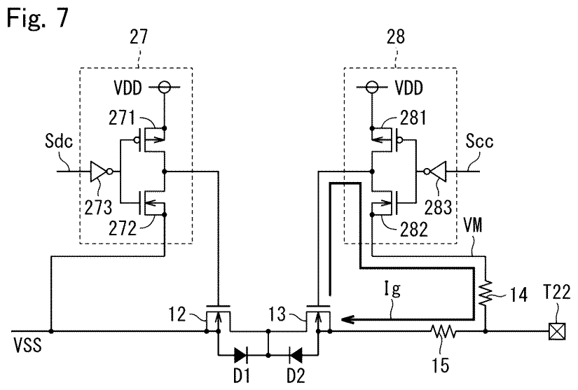

FIG. 7 is a schematic diagram of the discharge control driver 27 and the charge control driver 28 according to the first embodiment. The discharge control driver 27 includes a P-type MOS transistor 271, an N-type MOS transistor 272, and an inverter 273. The positive electrode power supply voltage VDD is applied to the source of the P-type MOS transistor 271. The gate of the P-type MOS transistor 271 is connected to the gate of the N-type MOS transistor 272. The drain of the P-type MOS transistor 271 is connected to the drain of the N-type MOS transistor 272. The source of the N-type MOS transistor 272 is connected to the negative electrode power supply terminal T12 having the negative electrode power supply voltage VSS. The connection point between the drain of the P-type MOS transistor 271 and the drain of the N-type MOS transistor 272 is connected to the gate of the discharge control transistor 12. The input terminal of the inverter 273 receives the discharge control signal Sdc. The output terminal of the inverter 273 is connected to the connection point between the gate of the P-type MOS transistor 271 and the gate of the N-type MOS transistor 272.

The inverter 273 generates a signal having a level obtained by inverting the level of the received discharge control signal Sdc and outputs the signal to the gate of the P-type MOS transistor 271 and the gate of the N-type MOS transistor 272. When the discharge control signal Sdc having a high level is input to the discharge control driver 27, the P-type MOS transistor 271 is turned on. As a result, the discharge control driver 27 generates the discharge control voltage DO having a high level based on the positive electrode power supply voltage VDD, and turns on the discharge control transistor 12. When the discharge control signal Sdc having a low level is input to the discharge control driver 27, the N-type MOS transistor 272 is turned on. As a result, the discharge control driver 27 generates the discharge control voltage DO having a low level based on the negative electrode power supply voltage VSS, and turns off the discharge control transistor 12.

The charge control driver 28 includes a P-type MOS transistor 281, an N-type MOS transistor 282, and an inverter 283. The positive electrode power supply voltage VDD is applied to the source of the P-type MOS transistor 281. The gate of the P-type MOS transistor 281 is connected to the gate of the N-type MOS transistor 282. The drain of the P-type MOS transistor 281 is connected to the drain of the N-type MOS transistor 282. The source of the N-type MOS transistor 282 is connected to the external negative electrode voltage input terminal T15 having the external negative electrode voltage VM. The connection point between the drain of the P-type MOS transistor 281 and the drain of the N-type MOS transistor 282 is connected to the gate of the charge control transistor 13. The input terminal of the inverter 283 receives the charge control signal Scc. The output terminal of the inverter 283 is connected to the connection point between the gate of the P-type MOS transistor 281 and the gate of the N-type MOS transistor 282.

The inverter 283 generates a signal having a level obtained by inverting the level of the received charge control signal Scc and outputs the signal to the gate of the P-type MOS transistor 281 and the gate of the N-type MOS transistor 282. When the charge control signal Scc having a high level is input to the charge control driver 28, the P-type MOS transistor 281 is turned on. As a result, the charge control driver 28 generates the charge control voltage CO having a high level based on the positive electrode power supply voltage VDD, and turns on the charge control transistor 13. When the charge control signal Scc having a low level is input to the charge control driver 28, the N-type MOS transistor 282 is turned on. As a result, the charge control driver 28 generates the charge control voltage CO having a low level based on the external negative electrode voltage VM, and turns off the charge control transistor 13.

When the charge control voltage CO having a low level is generated, the charge control transistor 13 is turned off because of extraction of the charges stored in the gate. For example, the charge moves to the source of the charge control transistor 13 via the N-type MOS transistor 282, the resistor 14, and the resistor 15, and the current Ig flows. Thus, a predetermined potential difference based on the current Ig is generated across the resistor 14, and the external negative electrode voltage VM rises above the current detection voltage CS.

It takes a predetermined time interval Toff to extract the charges stored in the gate of the charge control transistor 13. The predetermined time interval Toff may be a time required to extract most of the charges. For example, when the gate capacitance of the charge control transistor 13 is 10 nF and the resistance of the path through which the current flows is 10 kΩ, the time constant is, for example, 100 μs. In this case, the predetermined time interval Toff is, for example, about 300 μs.

When an anomaly state caused by an increase in the external negative electrode voltage VM due to the current Ig is detected within the predetermined time interval Toff after the charge control signal Scc having a low level is generated, a predetermined anomaly state may be erroneously detected. In recent years, there has been a demand to reduce the on-resistances of the discharge control transistor 12 and the charge control transistor 13 and the resistance of the shunt resistor 15 to suppress heat generation at the time of charging and discharging. When the element size of each of the transistors 12 and 13 is increased to reduce the on-resistances, the gate capacitance increases, and thus, the predetermined time interval Toff becomes longer than that of a transistor having a small element size. Thus, a time interval during which malfunction occurs due to erroneous detection may be long. In addition, when the resistance of the shunt resistor 15 is reduced, the potential difference across the shunt resistor 15 due to the current decreases, and thus, it is necessary to detect the short-circuit current or the overcurrent of charging and discharging with a smaller voltage. Thus, erroneous detection for a long time may occur as compared with a circuit having a large shunt resistor value.

To prevent malfunction due to erroneous detection of a predetermined anomaly state caused by a change in the charge control signal Scc, the charge and discharge control circuit 10 according to the present disclosure is configured not to accept an anomaly detection signal for a predetermined time interval from the change in the charge control signal Scc. With this configuration, even though a predetermined anomaly state caused by a change in the charge control signal Scc is erroneously detected, the charge control signal Scc is not controlled based on the erroneous detection. Thus, it is possible to prevent occurrence of malfunction due to the erroneous detection.

The charge and discharge control circuit 10 according to the first embodiment has a plurality of operation modes for holding at least one of the discharge control transistor 12 or the charge control transistor 13 in a predetermined state. The predetermined state includes an ON state and an OFF state. The plurality of operation modes include a normal mode, an overcharge protection mode, a short-circuit protection mode, and a charge control transition mode. The charge and discharge control circuit 10 is configured to operate in one of the plurality of operation modes. The charge and discharge control circuit 10 operates in a predetermined protection mode when a charging prohibition anomaly state or a discharging prohibition anomaly state is detected. The protection mode includes an overcharge protection mode and a short-circuit protection mode. The charge and discharge control circuit 10 may be configured to operate, for example, in a normal mode when resolution of the charging prohibition anomaly state or the discharging prohibition anomaly state is detected. The charge and discharge control circuit 10 may be configured to transition from the predetermined protection mode to the normal mode based on a signal from a circuit different from the anomaly detection circuit, instead of resolution of the charging prohibition anomaly state or the discharging prohibition anomaly state, during the operation in some protection modes. For example, the charge and discharge control circuit 10 is configured to transition from the short-circuit protection mode to the normal mode when receiving the charger connection detection signal Scd having a high level from the charger connection detection circuit 29 during the operation in the short-circuit protection mode. For example, when receiving the charger connection detection signal Scd having a high level during the operation in the short-circuit protection mode, the control circuit 20 generates the protection delay time measurement request Spdm having a high level. The protection delay time measurement request Spdm from the control circuit 20 can be output to an AND circuit (not illustrated) in addition to the time measurement circuit 23 and the AND circuits 24 and 25. When the control circuit 20 receives a predetermined delay time measurement stop request having a high level from the AND circuit, the charge and discharge control circuit 10 switches from the short-circuit protection mode to the normal mode. The AND circuit generates, for example, a logical AND of the protection delay time measurement request Spdm and a predetermined delay time elapse signal from the time measurement circuit 23 as the predetermined delay time measurement stop request. The time measurement circuit 23 can be configured to generate a predetermined delay time elapse signal having a high level after the predetermined delay time from occurrence of the protection delay time measurement request Spdm having a high level, for example. As described above, the charge and discharge control circuit 10 may be configured such that the transition from the normal mode to the predetermined protection mode and the transition from the predetermined protection mode to the normal mode occur based on signals from different detection circuits. The charge and discharge control circuit 10 operates in a predetermined transition mode when the level of the charge control signal Scc changes. The transition mode includes the charge control transition mode.

The normal mode is, for example, an operation mode performed when the condition for transitioning to a predetermined protection mode is not satisfied. In the normal mode, the charge and discharge control circuit 10 operates to hold the discharge control transistor 12 and the charge control transistor 13 in the ON state. Thus, in the normal mode, the control circuit 20 generates the discharge control signal Sdc having a high level and the charge control signal Scc having a high level.

The overcharge protection mode is an operation mode performed when overcharge of the secondary battery 11 is detected. When the overcharge detection circuit 21 detects a predetermined charging prohibition anomaly state based on the positive electrode power supply voltage VDD and the negative electrode power supply voltage VSS, the charge and discharge control circuit 10 transitions from, for example, the normal mode to the overcharge protection mode. In the overcharge protection mode, the charge and discharge control circuit 10 operates to hold the discharge control transistor 12 in the ON state and hold the charge control transistor 13 in the OFF state to prohibit charging. Thus, in the overcharge protection mode, the control circuit 20 generates the discharge control signal Sdc having a high level and generates the charge control signal Scc having a low level.

The short-circuit protection mode is an operation mode performed when an overcurrent in the discharge path of the secondary battery 11 is detected. The discharge path may be, for example, a closed circuit that flows from the positive electrode of the secondary battery 11 to the negative electrode of the secondary battery 11 via the load 2. When the short-circuit detection circuit 22 detects the discharging prohibition anomaly state based on the external negative electrode voltage VM and the current detection voltage CS, the charge and discharge control circuit 10 transitions from, for example, the normal mode to the short-circuit protection mode. In the short-circuit protection mode, the charge and discharge control circuit 10 operates to hold the discharge control transistor 12 in the OFF state and hold the charge control transistor 13 in the ON state to prohibit discharging. Thus, in the short-circuit protection mode, the control circuit 20 generates the discharge control signal Sdc having a low level and generates the charge control signal Scc having a high level.

The charge control transition mode is an operation mode performed when the level of the charge control signal Scc generated by the control circuit 20 changes. In the charge control transition mode, the charge and discharge control circuit 10 operates to hold the levels of the discharge control signal Sdc and the charge control signal Scc at the time of transition from any operation mode to the charge control transition mode. For example, when the discharge control signal Sdc has a high level and the charge control signal Scc changes from a high level to a low level, the charge and discharge control circuit 10 transitions from, for example, the normal mode to the charge control transition mode. When operating in the charge control transition mode, the charge and discharge control circuit 10 operates to hold the discharge control signal Sdc at a high level and hold the charge control signal Scc at a low level even though an anomaly detection signal having a high level is generated. When a predetermined time interval such as a predetermined time interval T2 elapses after operating in the charge control transition mode, the charge and discharge control circuit 10 transitions from the charge control transition mode to another operation mode.

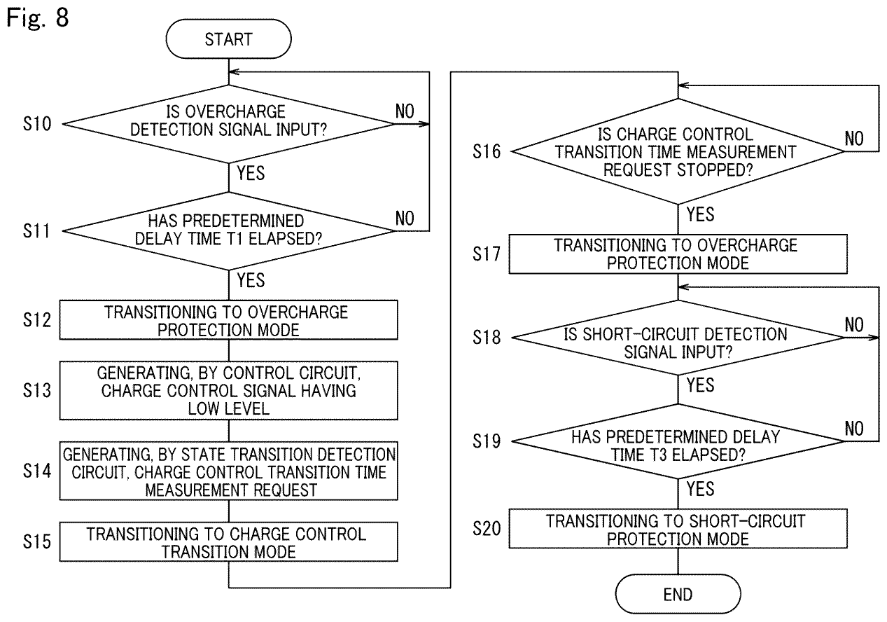

The operation of the charge and discharge control circuit 10 according to the first embodiment will be described. FIG. 8 is a flowchart illustrating an example of the operation of the charge and discharge control circuit 10 according to the first embodiment.

The charge and discharge control circuit 10 first operates in the normal mode, and generates the charge control signal Scc having a high level by the control circuit 20 The charge and discharge control circuit 10 determines, by the control circuit 20, whether the overcharge detection signal Socd having a high level is input (S10). When the overcharge detection signal Socd having a high level is not input (S10: No), the charge and discharge control circuit 10 performs step S10 again.

When the overcharge detection signal Socd having a high level is input (S10: Yes), the charge and discharge control circuit 10 determines, by the control circuit 20, whether the predetermined delay time T1 has elapsed from the input of the overcharge detection signal Socd having a high level (S11). For example, the control circuit 20 can determine whether the predetermined delay time T1 has elapsed based on the overcharge delay time elapse signal Socdp from the time measurement circuit 23.

When the predetermined delay time T1 has not elapsed from the input of the overcharge detection signal Socd having a high level (S11: No), the charge and discharge control circuit 10 performs step S10 again. When the predetermined delay time TI has elapsed (S11: Yes), the charge and discharge control circuit 10 transitions, for example, from the normal mode to the overcharge protection mode (S12). By operating in this manner, the charge and discharge control circuit 10 can determine whether the predetermined delay time T1 has elapsed from the input while the overcharge detection signal Socd having a high level is being input. When transitioning to the overcharge protection mode, the charge and discharge control circuit 10 generates, by the control circuit 20, the charge control signal Sec having a low level, and turns off the charge control transistor 13 via the charge control driver 28.

Next, the charge and discharge control circuit 10 generates, by the control circuit 20, the charge control signal Scc having a low level (S13). When the level of the charge control signal Scc changes, the charge and discharge control circuit 10 generates the charge control transition time measurement request Sctm having a high level by the state transition detection circuit 26 (S14). As a result, the charge and discharge control circuit 10 transitions from the overcharge protection mode to the charge control transition mode (S15). The charge and discharge control circuit 10 holds the state of each of the transistors 12 and 13 in the overcharge protection mode. That is, the charge and discharge control circuit 10 holds the discharge control transistor 12 in the ON state and holds the charge control transistor 13 in the OFF state.

The charge and discharge control circuit 10 determines, by the control circuit 20, whether the charge control transition time measurement request Sctm is stopped (S16). For example, when the charge control transition time measurement request Sctm changes from a high level to a low level, the charge and discharge control circuit 10 may determine that the charge control transition time measurement request Sctm has stopped. When the charge control transition time measurement request Sctm has not stopped (S16: No), the charge and discharge control circuit 10 performs step S16 again. When the charge control transition time measurement request Sctm has stopped (S16: Yes), the charge and discharge control circuit 10 transitions from the charge control transition mode to the overcharge protection mode (S17). During the operation in the charge control transition mode, the charge and discharge control circuit 10 does not accept an anomaly detection signal such as a short-circuit detection signal, and does not transition to a predetermined protection mode based on the anomaly detection signal.

Then, for example, the charge and discharge control circuit 10 determines, by the control circuit 20, whether the short-circuit detection signal Ssd having a high level is input (S18). When the short-circuit detection signal Ssd having a high level is not input (S18: No), the charge and discharge control circuit 10 performs step S18 again.

When the short-circuit detection signal Ssd having a high level is input (S18: Yes), the charge and discharge control circuit 10 determines, by the control circuit 20, whether the predetermined delay time T3 has elapsed from the input of the short-circuit detection signal Ssd having a high level (S19). For example, the control circuit 20 can determine whether the predetermined delay time T3 has elapsed based on short-circuit delay time elapse signal Ssdp from the time measurement circuit 23.

When the predetermined delay time T3 has not elapsed from the input of the short-circuit detection signal Ssd having the high level (S19: No), the charge and discharge control circuit 10 performs step S18 again. When the predetermined delay time T3 has elapsed (S19: Yes), the charge and discharge control circuit 10 transitions, for example, from the overcharge protection mode to the short-circuit protection mode (S20). By operating in this manner, the charge and discharge control circuit 10 can determine whether the predetermined delay time T3 has elapsed from the input while the short-circuit detection signal Ssd is being input. When transitioning to the short-circuit protection mode, the charge and discharge control circuit 10 generates, by the control circuit 20, the discharge control signal Sdc having a low level, and turns off the discharge control transistor 12 via the discharge control driver 27. In this manner, after transitioning from the charge control transition mode to another mode, the charge and discharge control circuit 10 accepts an anomaly detection signal such as a short-circuit detection signal, and can transition to a predetermined protection mode after an elapse of a predetermined delay time based on the anomaly detection signal.

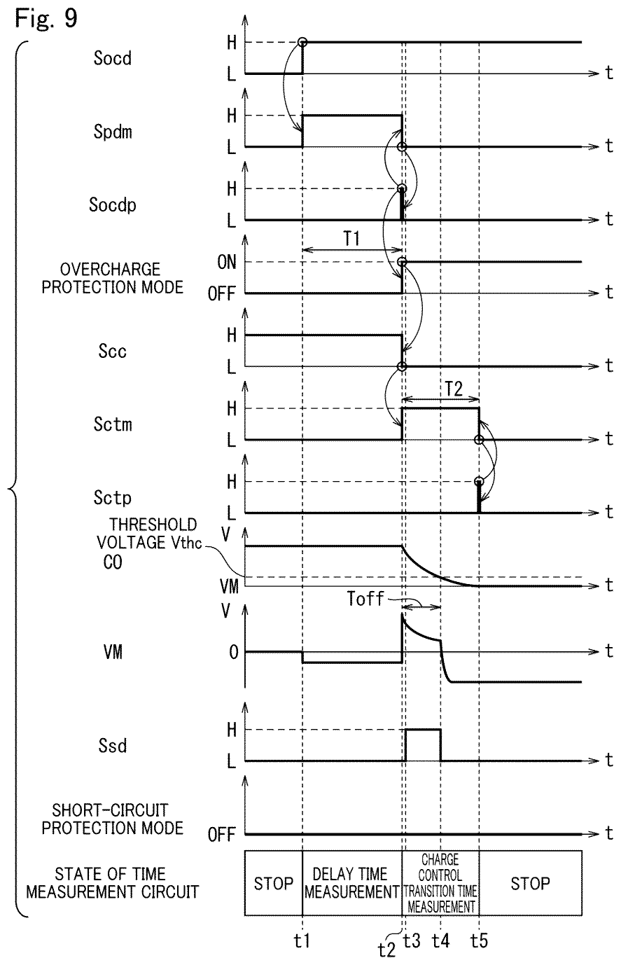

FIG. 9 is a timing chart illustrating an example of the operation of the charge and discharge control circuit 10 according to the first embodiment. The example illustrated in FIG. 9 illustrates a timing chart related to the overcharge protection mode. The horizontal axis in FIG. 9 represents the time. The vertical axes in FIG. 9 represent the level of the overcharge detection signal Socd, the level of the protection delay time measurement request Spdm, the level of the overcharge delay time elapse signal Socdp, the state of the overcharge protection mode, the level of the charge control signal Scc, the level of the charge control transition time measurement request Sctm, the level of the charge control transition time elapse signal Sctp, the charge control voltage CO, the external negative electrode voltage VM, the level of the short-circuit detection signal Ssd, the state of the short-circuit protection mode, and the state of the time measurement circuit 23, respectively. In FIG. 9 and FIGS. 10 and 14 described later, the waveform of the predetermined protection mode such as the overcharge protection mode is indicated by ON when the condition for operating in the protection mode is satisfied, and is indicated by OFF when the condition for releasing the operation in the protection mode is satisfied.

In the timing chart illustrated in FIG. 9, the charge and discharge control circuit 10 operates in the normal mode before time t1. When the overcharge detection circuit 21 generates the overcharge detection signal Socd having a high level at time t1, the control circuit 20 generates the protection delay time measurement request Spdm having a high level. When receiving the protection delay time measurement request Spdm having a high level, the time measurement circuit 23 generates the overcharge delay time elapse signal Socdp having a high level at time t2 after a predetermined delay time T1 related to overcharge protection from occurrence of the protection delay time measurement request Spdm having a high level. When receiving the overcharge delay time measurement stop request Socms having a high level from the AND circuit 24, the control circuit 20 generates the protection delay time measurement request Spdm having a low level. In addition, the charge and discharge control circuit 10 transitions from the normal mode to the overcharge protection mode.

In the overcharge protection mode, the control circuit 20 generates the charge control signal Scc having a low level so as to turn off the charge control transistor 13. In response to a change of the charge control signal Scc from a high level to a low level, the state transition detection circuit 26 latches and generates the charge control transition time measurement request Sctm having a high level. The charge and discharge control circuit 10 transitions from the overcharge protection mode to the charge control transition mode based on the occurrence of the charge control transition time measurement request Sctm having a high level. When receiving the charge control signal Scc having a low level, the charge control driver 28 reduces the charge control voltage CO to, for example, the external negative electrode voltage VM to turn off the charge control transistor 13. The charge control voltage CO corresponds to the gate voltage of the charge control transistor 13. When the gate voltage decreases, as illustrated in FIG. 7, the external negative electrode voltage VM increases due to the current based on the discharge of the charges stored in the gate of the charge control transistor 13.

When the differential voltage between the external negative electrode voltage VM and the current detection voltage CS becomes equal to or greater than a predetermined threshold voltage, the short-circuit detection circuit 22 generates the short-circuit detection signal Ssd having a high level due to erroneous detection of the discharging prohibition anomaly state at time t3 after a predetermined time. However, because the charge and discharge control circuit 10 is operating in the charge control transition mode, the control circuit 20 does not accept the short-circuit detection signal Ssd having a high level. For example, even when receiving the short-circuit detection signal Ssd having a high level, the control circuit 20 does not generate the protection delay time measurement request Spdm having a high level. In this manner, even though the short-circuit detection circuit 22 generates the short-circuit detection signal Ssd having a high level due to erroneous detection, the control circuit 20 does not accept the short-circuit detection signal Ssd having a high level. Thus, the control circuit 20 does not generate the protection delay time measurement request Spdm having a high level. The control circuit 20 prohibits generation of the protection delay time measurement request Spdm having a high level until the predetermined time interval T2 elapses from occurrence of the charge control transition time measurement request Sctm having a high level. Thus, while the charge control transition time measurement request Sctm having a high level is generated, the control circuit 20 holds the level of the charge control signal Scc at the level at the time of occurrence of the charge control transition time measurement request Sctm having a high level.

After time t3, the charge control voltage CO gradually decreases because of discharge of charges. When the charge control voltage CO becomes less than a threshold voltage Vthc of the charge control transistor 13 at time t4 after the predetermined time interval Toff from the time t3, the charge control transistor 13 is turned off. When the charge control transistor 13 is turned off, the external negative electrode voltage VM is pulled down by the charger voltage of the charger connected as the load 2. As a result, the short-circuit detection circuit 22 generates the short-circuit detection signal Ssd having a low level. In this manner, even though erroneous detection of a short circuit has occurred during the charge control transition mode, the charge and discharge control circuit 10 does not transition to the short-circuit protection mode.

When receiving the charge control transition time measurement request Sctm having a high level at time t2, the time measurement circuit 23 generates the charge control transition time elapse signal Sctp having a high level at time t5 after the predetermined time interval T2 related to charging from occurrence of the charge control transition time measurement request Sctm. When receiving the charge control transition time elapse signal Sctp having a high level, the state transition detection circuit 26 releases the latch and generates the charge control transition time measurement request Sctm having a low level. As a result, the charge and discharge control circuit 10 transitions from the charge control transition mode to the overcharge protection mode. Thus, the control circuit 20 accepts the protection detection signal such as the short-circuit detection signal Ssd after time t5. That is, the control circuit 20 lifts the prohibition of generation of the protection delay time measurement request Spdm having a high level.

As illustrated in FIG. 9, the time measurement circuit 23 stops counting before time t1. At time t1, the time measurement circuit 23 counts the delay time T1 related to overcharge until time t2. At time t2, the time measurement circuit 23 resets the counting state and counts the predetermined time interval T2 related to charging until time t5. The time measurement circuit 23 stops counting after time t5.

In this manner, the charge and discharge control circuit 10 can turn off the charge control transistor 13 without transitioning to the short-circuit protection mode even though erroneous detection of a short circuit occurs when the charge control transistor 13 is turned off due to detection of an anomaly state related to overcharge. Thus, the charge and discharge control circuit 10 can protect the battery device 1 by appropriately turning off the charge control transistor 13 when overcharge has occurred.

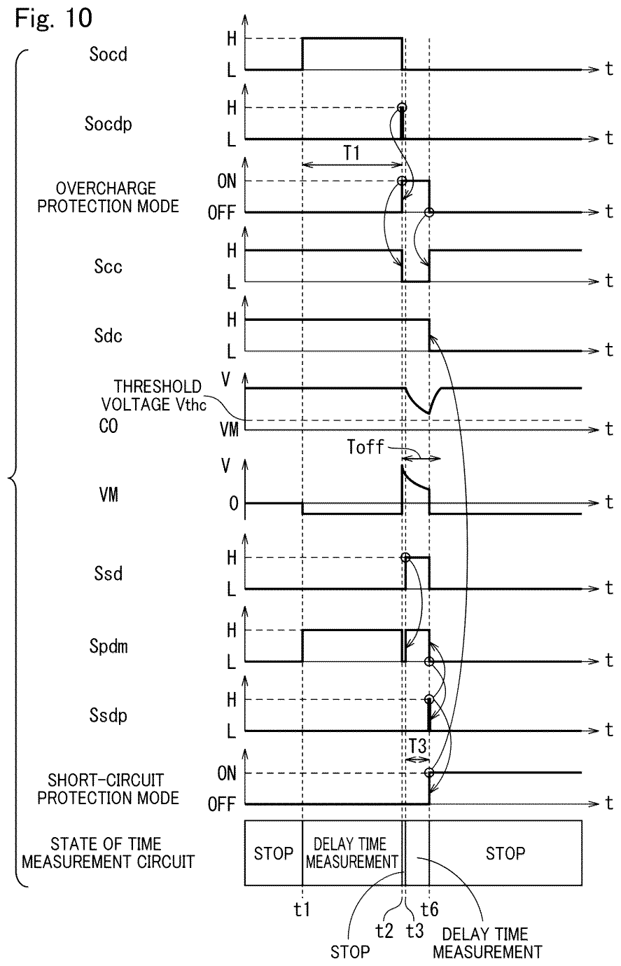

FIG. 10 is a timing chart illustrating an example of the operation of the charge and discharge control circuit according to a comparative example. As compared with the charge and discharge control circuit 10 according to the first embodiment, the charge and discharge control circuit does not include the state transition detection circuit 26 or the AND circuits 24 to 25. The example illustrated in FIG. 10 illustrates a timing chart related to the overcharge protection mode. The horizontal axis in FIG. 10 represents the time. The vertical axes in FIG. 10 represent the level of the overcharge detection signal Socd, the level of the overcharge delay time elapse signal Socdp, the state of the overcharge protection mode, the level of the charge control signal Scc, the level of the discharge control signal Sdc, the charge control voltage CO, the external negative electrode voltage VM, the level of the short-circuit detection signal Ssd, the level of the protection delay time measurement request Spdm, the level of the short-circuit delay time elapse signal Ssdp, the state of the short-circuit protection mode, and the state of the time measurement circuit 23, respectively.

Between time t1 and time t2, the charge and discharge control circuit according to the comparative example operates similarly to the charge and discharge control circuit 10. When the differential voltage between the external negative electrode voltage VM and the current detection voltage CS becomes equal to or greater than a predetermined threshold voltage at time t2, the short-circuit detection circuit generates the short-circuit detection signal Ssd having a high level due to erroneous detection of the discharging prohibition anomaly state at time t3 after a predetermined time. When receiving the short-circuit detection signal Ssd having a high level, the control circuit according to the comparative example generates the protection delay time measurement request Spdm having a high level.

In the present comparative example, the predetermined time interval Toff is longer than the predetermined delay time T3 related to short-circuit protection. When receiving the protection delay time measurement request Spdm having a high level, the time measurement circuit generates the short-circuit delay time elapse signal Ssdp having a high level at time t6 after the delay time T3 from time t3. The control circuit generates the protection delay time measurement request Spdm having a low level based on generation of the short-circuit delay time elapse signal Ssdp having a high level. In addition, the charge and discharge control circuit transitions from the overcharge protection mode to the short-circuit protection mode.

Thus, the control circuit generates the charge control signal Scc having a high level and generates the discharge control signal Sdc having a low level. Because the charge control signal Scc changes to a high level before the elapse of the predetermined time interval Toff, the charge control transistor 13 is held in the ON state. In this manner, even though the charge and discharge control circuit according to the comparative example detects an anomaly related to overcharge, the charge and discharge control circuit may transition from the overcharge protection mode to the short-circuit protection mode, and the charge control transistor 13 may not be turned off. Thus, the charge and discharge control circuit according to the comparative example may not appropriately protect the secondary battery because the charge and discharge control circuit permits charging and prohibits discharging due to the unintended mode transition despite the situation where charging should be prohibited.

When detecting a change in the level of the charge control signal Scc, the charge and discharge control circuit 10 according to the present disclosure does not transition from the protection mode at the time of the change to another protection mode for a predetermined time interval T2 from the detection. Thus, the control circuit 20 does not accept an anomaly detection signal such as the short-circuit detection signal Ssd. For example, even though the short-circuit detection signal Ssd having a high level is generated, the measurement request for the delay time T3 for transitioning to the short-circuit detection mode is not made. Thus, the charge and discharge control circuit 10 according to the present disclosure can prevent an unintended mode transition due to transient rise in the external negative electrode voltage VM caused by turning off of the charge control transistor 13. Thus, the charge and discharge control circuit 10 according to the present disclosure can prevent malfunction of the charge and discharge control circuit 10 due to an increase in the external negative electrode voltage VM and protect the battery device 1.

### Second Embodiment

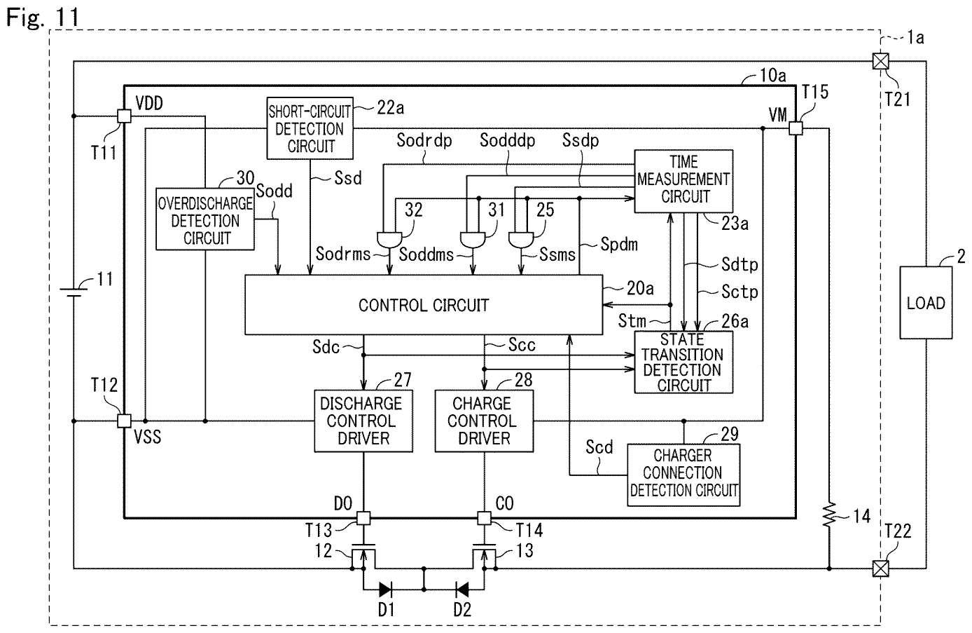

An overview of a battery device la according to a second embodiment of the present disclosure will be described with reference to FIG. 11. FIG. 11 is a schematic diagram of the battery device 1a according to the second embodiment of the present disclosure. The battery device 1a includes a charge and discharge control circuit 10a instead of the charge and discharge control circuit 10 in the first embodiment. The charge and discharge control circuit 10a includes a control circuit 20a, an overdischarge detection circuit 30, a short-circuit detection circuit 22a, a time measurement circuit 23a, and a state transition detection circuit 26a instead of the control circuit 20, the overcharge detection circuit 21, the short-circuit detection circuit 22, the time measurement circuit 23, and the state transition detection circuit 26. In addition, the charge and discharge control circuit 10a includes AND circuits 31 and 32 instead of the AND circuit 24.

The charge and discharge control circuit 10a has one or more protection modes for controlling the discharge control transistor 12 or the charge control transistor 13 to be in a predetermined state based on an anomaly detection signal from an anomaly detection circuit such as the overdischarge detection circuit 30 or the short-circuit detection circuit 22a.

For example, the charge and discharge control circuit 10a transitions from, for example, the normal mode to the overdischarge protection mode after a predetermined delay time based on an overdischarge detection signal Sodd having a high level. The control circuit 20a generates the discharge control signal Sdc having a low level based on the overdischarge detection signal Sodd having a high level from the overdischarge detection circuit 30, and outputs the discharge control signal Sdc to the discharge control driver 27 and the state transition detection circuit 26a. The discharge control driver 27 turns off the discharge control transistor 12 based on the discharge control signal Sdc having a low level. Then, the control circuit 20a controls the discharge control signal Sdc to hold the discharge control transistor 12 off during the overdischarge protection mode. The charge and discharge control circuit 10a transitions from the overdischarge protection mode to, for example, the normal mode after predetermined delay time T4 based on the overdischarge detection signal Sodd having a low level. The control circuit 20a generates the discharge control signal Sdc having a high level based on the overdischarge detection signal Sodd having a low level from the overdischarge detection circuit 30, turns on the discharge control transistor 12 via the discharge control driver 27, and controls the discharge control signal Sdc to hold the discharge control transistor 12 on during the normal mode. The delay time for transition to the overdischarge protection mode may be the same as or different from delay time T4 for recovery from the overdischarge protection mode. The delay time for transition to the protection mode related to the discharging prohibition anomaly state is an example of the fourth time interval. The delay time for recovery from the protection mode related to the discharging prohibition anomaly state such as delay time T4 is an example of the fifth time interval.

When receiving the anomaly detection signal having a high level, the control circuit 20a generates the protection delay time measurement request Spdm having a high level and outputs the protection delay time measurement request Spdm to the time measurement circuit 23a, the AND circuit 25, the AND circuit 31, and the AND circuit 32. When receiving the charger connection detection signal Sed having a high level, the control circuit 20a also generates the protection delay time measurement request Spdm having a high level and outputs the protection delay time measurement request Spdm to the time measurement circuit 23a, the AND circuit 25, the AND circuit 31, and the AND circuit 32. The control circuit 20a receives a delay time lapse signal having a high level after a predetermined delay time from the occurrence. The charge and discharge control circuit 10a switches from, for example, the normal mode to a predetermined protection mode based on the delay time elapse signal having a high level. The delay time elapse signal includes, for example, the short-circuit delay time elapse signal Ssdp, an overdischarge detection delay time elapse signal Sodddp, and an overdischarge recovery delay time elapse signal Sodrdp described later. For example, when the overdischarge recovery delay time elapse signal Sodrdp having a high level is generated during generation of the protection delay time measurement request Spdm having a high level based on stopping of generation of the overdischarge detection signal Sodd, the charge and discharge control circuit 10a switches from the overdischarge protection mode to the normal mode. For example, during the operation in the short-circuit protection mode, when the overdischarge recovery delay time elapse signal Sodrdp having a high level is generated during generation of the protection delay time measurement request Spdm having a high level based on generation of the charger connection detection signal Scd having a high level, the charge and discharge control circuit 10a switches from the short-circuit protection mode to the normal mode. The control circuit 20a generates a protection delay time measurement request Spdm having a low level based on the short-circuit delay time elapse signal Ssdp, the overdischarge detection delay time elapse signal Sodddp or the overdischarge recovery delay time elapse signal Sodrdp having a high level. In the present embodiment, the charge and discharge control circuit 20a is configured to measure the delay time related to recovery from the short-circuit protection mode using the overdischarge recovery delay time elapse signal Sodrdp, but the charge and discharge control circuit 20a is not limited to this configuration. For example, the charge and discharge control circuit 20a may further include an AND circuit that generates a logical AND of the protection delay time measurement request Spdm and the short-circuit recovery delay time elapse signal from the time measurement circuit 23a and outputs the logical AND to the control circuit 20a. For example, the time measurement circuit 23a is configured to generate the short-circuit recovery delay time elapse signal having a high level after the delay time related to the recovery from the short-circuit protection mode from occurrence of the protection delay time measurement request Spdm having a high level, whereby the charge and discharge control circuit 20a can be configured such that the delay time T4 related to the recovery from the overdischarge protection mode is different from the delay time related to the recovery from the short-circuit protection mode.

When the control circuit 20a receives a control transition time measurement request Stm having a high level to be described later based on a change in the discharge control signal Sdc, the charge and discharge control circuit 10a transitions from any operation mode to a discharge control transition mode. In the discharge control transition mode, the control circuit 20a operates so as not to change the levels of the charge control signal Scc and the discharge control signal Sdc even when receiving the anomaly detection signal. When the control circuit 20a receives the control transition time measurement request Stm having a low level, the charge and discharge control circuit 10a transitions from the discharge control transition mode to any operation mode. For example, the control circuit 20a lifts prohibition of generation of the protection delay time measurement request Spdm having a high level.

The overdischarge detection circuit 30 receives the positive electrode power supply voltage VDD and the negative electrode power supply voltage VSS. The overdischarge detection circuit 30 generates the overdischarge detection signal Sodd based on the differential voltage between the positive electrode power supply voltage VDD and the negative electrode power supply voltage VSS, and outputs the overdischarge detection signal Sodd to the control circuit 20a. When detecting that the differential voltage is less than a predetermined overdischarge detection voltage, the overdischarge detection circuit 30 generates the overdischarge detection signal Sodd having a high level. When detecting that the differential voltage is equal to or greater than the overdischarge recovery voltage, the overdischarge detection circuit 30 generates the overdischarge detection signal Sodd having a low level. The overdischarge detection voltage may be, for example, 2.6 V. The overdischarge recovery voltage may be, for example, 2.6 V.

The overdischarge detection circuit 30 is an example of an anomaly detection circuit. The overdischarge detection signal Sodd is an example of the anomaly detection signal and the discharging anomaly detection signal. The condition that the differential voltage between the positive electrode power supply voltage VDD and the negative electrode power supply voltage VSS is less than the predetermined overdischarge detection voltage is an example of the discharging prohibition anomaly state. The condition that the differential voltage is equal to or greater than the predetermined overdischarge recovery voltage is an example of resolution of the discharging prohibition anomaly state. The overdischarge detection circuit 30 generating the overdischarge detection signal Sodd having a high level is an example of the overdischarge detection circuit 30 generating the anomaly detection signal. The overdischarge detection circuit 30 generating the overdischarge detection signal Sodd having a low level is an example of the overdischarge detection circuit 30 stopping generation of the anomaly detection signal.

The short-circuit detection circuit 22a receives the external negative electrode voltage VM and the negative electrode power supply voltage VSS. The short-circuit detection circuit 22a generates the short-circuit detection signal Ssd based on the differential voltage between the external negative electrode voltage VM and the negative electrode power supply voltage VSS, and outputs the short-circuit detection signal Ssd to the control circuit 20a. When detecting that the differential voltage is equal to or greater than a predetermined short-circuit detection voltage, the short-circuit detection circuit 22a generates the short-circuit detection signal Ssd having a high level. When detecting that the differential voltage is less than the short-circuit recovery voltage, the short-circuit detection circuit 22a generates the short-circuit detection signal Ssd having a low level. The short-circuit detection voltage may be, for example, 1 V.

The time measurement circuit 23a generates an overdischarge detection delay time elapse signal Sodddp having a predetermined level and outputs the overdischarge detection delay time elapse signal Sodddp to the AND circuit 31. The time measurement circuit 23a generates an overdischarge recovery delay time elapse signal Sodrdp having a predetermined level and outputs the overdischarge recovery delay time elapse signal Sodrdp to the AND circuit 32. The time measurement circuit 23a generates the charge control transition time elapse signal Sctp or the discharge control transition time elapse signal Sdtp having a predetermined level and outputs the signal to the state transition detection circuit 26a. The time measurement circuit 23a counts a predetermined time interval based on the protection delay time measurement request Spdm or a control transition time measurement request Stm to be described later having a high level, and generates time elapse signals Ssdp, Sctp, Sdtp, Sodddp, and Sodrdp having a high level. The time measurement circuit 23a generates time elapse signals Ssdp, Sctp, Sdtp, Sodddp, and Sodrdp having a low level based on the protection delay time measurement request Spdm and the control transition time measurement request Stm having a low level. The time measurement circuit 23a resets counting based on the protection delay time measurement request Spdm and the control transition time measurement request Stm having a low level.

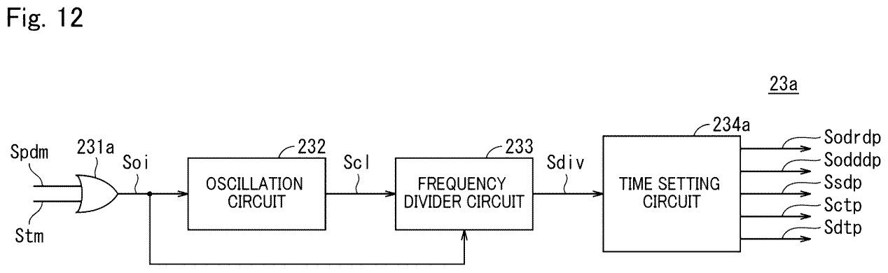

FIG. 12 is a schematic diagram of the time measurement circuit 23a according to the second embodiment. The time measurement circuit 23a according to the second embodiment includes an OR circuit 231a, an oscillation circuit 232, a frequency divider circuit 233, and a time setting circuit 234a.

The OR circuit 231a generates the oscillation instruction signal Soi having a predetermined level based on the input protection delay time measurement request Spdm and control transition time measurement request Stm, and outputs the oscillation instruction signal Soi to the oscillation circuit 232 and the frequency divider circuit 233. When at least one of the protection delay time measurement request Spdm or the control transition time measurement request Stm has a high level, the OR circuit 231a generates the oscillation instruction signal Soi having a high level. When both the protection delay time measurement request Spdm and the control transition time measurement request Stm have a low level, the OR circuit 231a generates the oscillation instruction signal Soi having a low level.

Based on the frequency-divided signals Sdiv, the time setting circuit 234a counts a predetermined delay time and generates time elapse signals Ssdp, Sctp, Sdtp, Sodddp, and Sodrdp having a high level.

The AND circuit 31 illustrated in FIG. 11 generates an overdischarge detection delay time measurement stop request Soddms having a level representing the logical AND of the protection delay time measurement request Spdm and the overdischarge detection delay time elapse signal Sodddp, and outputs the overdischarge detection delay time measurement stop request Soddms to the control circuit 20a.

The AND circuit 32 generates an overdischarge recovery delay time measurement stop request Sodrms having a level representing the logical AND of the protection delay time measurement request Spdm and the overdischarge recovery delay time elapse signal Sodrdp, and outputs the overdischarge recovery delay time measurement stop request Sodrms to the control circuit 20a.

The state transition detection circuit 26a generates the control transition time measurement request Stm based on the charge control signal Scc or the discharge control signal Sdc, and outputs the control transition time measurement request Stm to the control circuit 20a and the time measurement circuit 23a. When the level of the charge control signal Scc changes, the state transition detection circuit 26a generates the control transition time measurement request Stm having a high level. The state transition detection circuit 26a generates the control transition time measurement request Stm having a low level after the elapse of the predetermined time interval T2. When the level of the discharge control signal Sdc changes, the state transition detection circuit 26a generates the control transition time measurement request Stm having a high level. The state transition detection circuit 26a generates the control transition time measurement request Stm having a low level after the elapse of the predetermined time interval T5. Specifically, when receiving the charge control transition time elapse signal Sctp or the discharge control transition time elapse signal Sdtp having a high level, the state transition detection circuit 26a generates the control transition time measurement request Stm having a low level. The control transition time measurement request Stm is an example of the first count request signal. The discharge control transition time elapse signal Sdtp is an example of the first time interval elapse signal. The predetermined time interval T5 may be the same as or different from the predetermined time interval T2. The predetermined time interval T5 is an example of the first time interval and the seventh time interval.

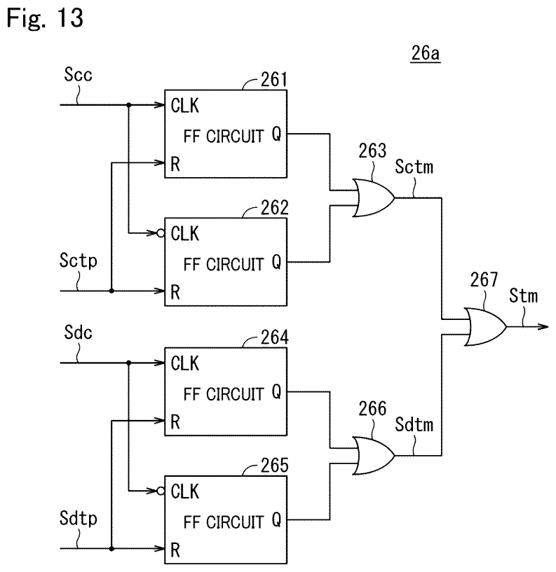

FIG. 13 is a schematic diagram of the state transition detection circuit 26a according to the second embodiment. Compared with the state transition detection circuit 26, the state transition detection circuit 26a further includes FF circuits 264 and 265 and OR circuits 266 and 267. Each of the FF circuit 264 and the FF circuit 265 generates a signal based on both the discharge control signal Sdc and the discharge control transition time elapse signal Sdtp, and outputs the signal to the OR circuit 266. The OR circuit 267 generates the control transition time measurement request Stm based on the signal from the OR circuit 263 and the signal from the OR circuit 266.

The FF circuit 264 includes a terminal CLK to which the discharge control signal Sdc is input, a terminal R to which the discharge control transition time elapse signal Sdtp is input, and a terminal Q that generates a signal having a predetermined level based on the input signal. The FF circuit 265 includes a terminal CLK to which the inverted value of the discharge control signal Sdc is input, a terminal R to which the discharge control transition time elapse signal Sdtp is input, and a terminal Q that generates a signal having a predetermined level based on the input signal. The FF circuit 264 operates similarly to the FF circuit 261 based on the discharge control signal Sdc and the discharge control transition time elapse signal Sdtp. The FF circuit 265 operates similarly to the FF circuit 262 based on the discharge control signal Sdc and the discharge control transition time elapse signal Sdtp.

The OR circuit 266 generates the discharge control transition time measurement request Sdtm having a level representing the logical OR of the signal from the FF circuit 264 and the signal from the FF circuit 265.

The OR circuit 267 generates the control transition time measurement request Stm having a level representing the logical OR of the charge control transition time measurement request Sctm from the OR circuit 263 and the discharge control transition time measurement request Sdtm from the OR circuit 266.

In the charge and discharge control circuit 10a according to the second embodiment, the plurality of operation modes further include an overdischarge protection mode and a discharge control transition mode. The protection mode further includes an overdischarge protection mode. The charge and discharge control circuit 10a operates in a predetermined transition mode when at least one of the level of the discharge control signal Sdc or the level of the charge control signal Scc changes. The transition mode further includes a discharge control transition mode.

The overdischarge protection mode is an operation mode performed when overdischarge of the secondary battery 11 is detected. When the overdischarge detection circuit 30 detects a predetermined discharging prohibition anomaly state based on the positive electrode power supply voltage VDD and the negative electrode power supply voltage VSS, the charge and discharge control circuit 10a transitions from, for example, the normal mode to the overdischarge protection mode. In the overdischarge protection mode, the charge and discharge control circuit 10a operates to hold the discharge control transistor 12 in the OFF state to prohibit discharging and hold the charge control transistor 13 in the ON state. Thus, in the overdischarge protection mode, the control circuit 20a generates the discharge control signal Sdc having a low level and generates the charge control signal Scc having a high level.

The discharge control transition mode is an operation mode performed when the level of the discharge control signal Sdc generated by the control circuit 20a changes. In the discharge control transition mode, the charge and discharge control circuit 10a operates similarly to the charge control transition mode. When a predetermined time interval such as a predetermined time interval T5 elapses after operating in the discharge control transition mode, the charge and discharge control circuit 10a transitions from the discharge control transition mode to another operation mode.

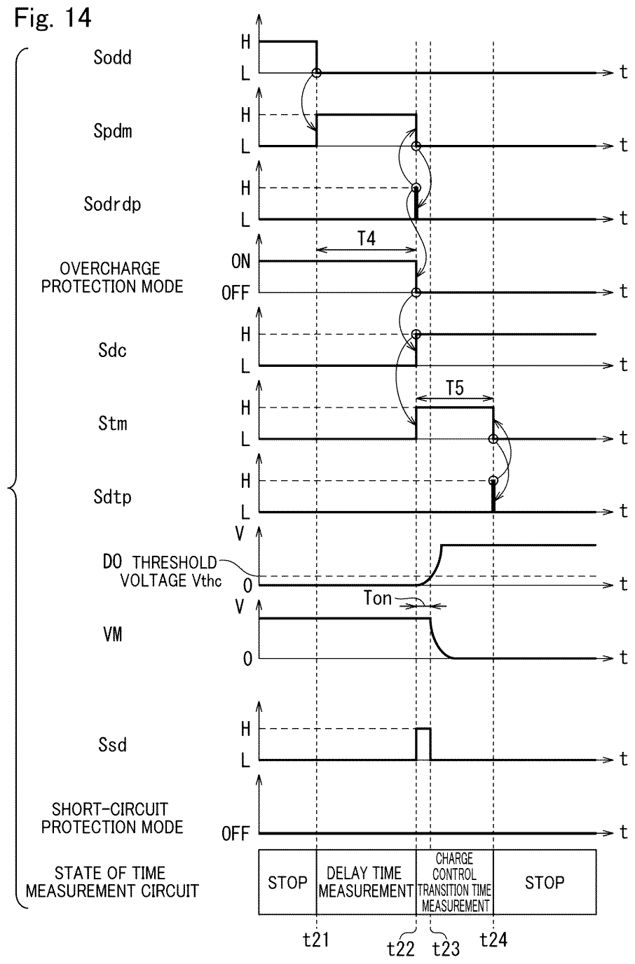

FIG. 14 is a timing chart illustrating an example of the operation of the charge and discharge control circuit 10a according to the second embodiment. The example illustrated in FIG. 14 illustrates a timing chart related to the overdischarge protection mode. The horizontal axis in FIG. 14 represents the time. In FIG. 14, the vertical axes represent the level of the overdischarge detection signal Sodd, the level of the protection delay time measurement request Spdm, the level of the overdischarge recovery delay time elapse signal Sodrdp, the state of the overdischarge protection mode, and the level of the discharge control signal Sdc, respectively. The vertical axes in FIG. 14 represent the level of the control transition time measurement request Stm, the level of the discharge control transition time elapse signal Sdtp, the discharge control voltage DO, the external negative electrode voltage VM, the level of the short-circuit detection signal Ssd, the state of the short-circuit protection mode, and the state of the time measurement circuit 23a, respectively.

In the timing chart illustrated in FIG. 14, the charge and discharge control circuit 10a operates in the overdischarge protection mode before time t21. At time t21, when the overdischarge detection circuit 30 detects resolution of an anomaly state related to overdischarge and generates the overdischarge detection signal Sodd having a low level, the control circuit 20a generates the protection delay time measurement request Spdm having a high level. For example, the overdischarge detection circuit 30 may generate the protection delay time measurement request Spdm having a high level when the positive electrode power supply voltage VDD has become greater than the overdischarge recovery voltage. When receiving the protection delay time measurement request Spdm having a high level, the time measurement circuit 23a generates the overdischarge recovery delay time elapse signal Sodrdp having a high level at time t22 after the predetermined delay time T4 related to recovery of overdischarge protection. When receiving the overdischarge recovery delay time measurement stop request Sodrms having a high level from the AND circuit 32, the control circuit 20a generates the protection delay time measurement request Spdm having a low level. In addition, the charge and discharge control circuit 10a transitions from the overdischarge protection mode to the normal mode.

When the overdischarge protection mode transitions to the normal mode, the control circuit 20a generates the discharge control signal Sdc having a high level so as to turn on the discharge control transistor 12. In response to the change from a low level to a high level of the discharge control signal Sdc, the state transition detection circuit 26a latches and generates the control transition time measurement request Stm having a high level. When receiving the discharge control signal Sdc having a high level, the discharge control driver 27 increases the discharge control voltage DO to, for example, the positive electrode power supply voltage VDD to turn on the discharge control transistor 12.

During the time interval from time 122 to time t23, because the discharge control voltage DO has not yet sufficiently increased, the discharge control transistor 12 is in an OFF state. Thus, during this time interval, the external negative electrode voltage VM is held in a state of being pulled up by the load 2, and the short-circuit detection circuit 22a generates the short-circuit detection signal Ssd having a high level due to erroneous detection of the discharging prohibition anomaly state at time t22. However, because the charge and discharge control circuit 10a is operating in the discharge control transition mode, the control circuit 20a does not accept the short-circuit detection signal Ssd having a high level. In this manner, the control circuit 20a prohibits generation of the protection delay time measurement request Spdm having a high level until the predetermined time interval T5 elapses from occurrence of the control transition time measurement request Stm having a high level.

At time t23 after a predetermined time interval Ton from time t22, when the discharge control voltage DO increases to be equal to or greater than the threshold voltage Vthd of the discharge control transistor, the discharge control transistor 12 is turned on. Thus, the external negative electrode voltage VM is pulled down to the negative electrode power supply voltage VSS. The predetermined time interval Ton may be, for example, a time interval from when the P-type MOS transistor 271 of the discharge control driver 27 is turned on to when the discharge control transistor 12 is turned on. Due to the decrease in the external negative electrode voltage VM, the short-circuit detection circuit 22a stops erroneous detection and generates the short-circuit detection signal Ssd having a low level. In this manner, even though erroneous detection of a short circuit occurs during the discharge control transition mode, the charge and discharge control circuit 10a does not transition to the short-circuit protection mode.

When receiving the control transition time measurement request Stm having a high level at time t22, the time measurement circuit 23a generates the discharge control transition time elapse signal Sdtp having a high level at time t24 after the predetermined time interval T5 related to discharge from occurrence of the discharge control transition time measurement request Sdtm. When receiving the discharge control transition time elapse signal Sdtp having a high level, the state transition detection circuit 26a releases the latch and generates the control transition time measurement request Stm having a low level. This causes the charge and discharge control circuit 10a to transition from the discharge control transition mode to the normal mode. Thus, the control circuit 20a accepts the protection detection signal such as the short-circuit detection signal Ssd after time 124. That is, the control circuit 20a lifts the prohibition of generation of the protection delay time measurement request Spdm having a high level.

As illustrated in FIG. 14, the time measurement circuit 23a stops counting before time t21. At time t21, the time measurement circuit 23a counts the delay time T4 related to overdischarge recovery until time t22. At time t22, the time measurement circuit 23a resets the counting state and counts the predetermined time interval T5 related to discharge until time t24. The time measurement circuit 23a stops counting after time t24.

In this manner, the charge and discharge control circuit 10a can turn on the discharge control transistor 12 without transitioning to the short-circuit protection mode even though erroneous detection of a short circuit occurs when the discharge control transistor 12 is turned on due to detection of recovery of an anomaly state related to overdischarge. Thus, the charge and discharge control circuit 10a can appropriately turn on the discharge control transistor 12 at the time of recovery from the protection mode against overdischarge to prevent malfunction.

### Modification

In the second embodiment described above, the time measurement circuit 23a generates a predetermined time elapse signal having a high level by the oscillation circuit 232, the frequency divider circuit 233, and the time setting circuit 234a. However, the time measurement circuit 23a may be configured to generate a time elapse signal by another configuration.

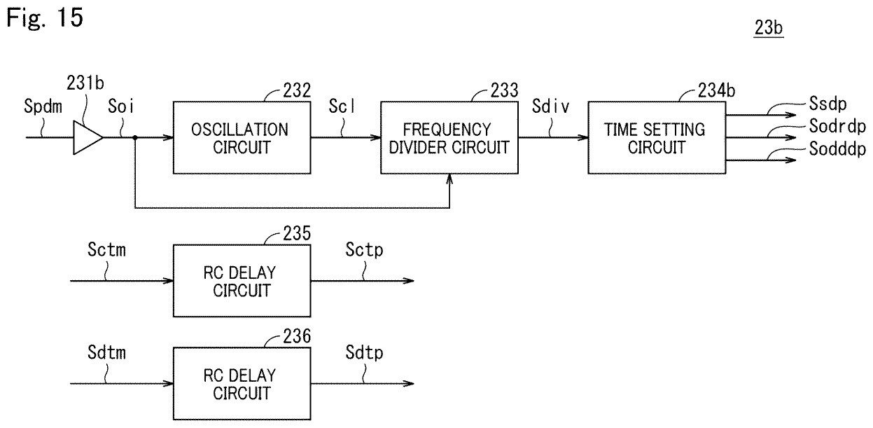

FIG. 15 is a schematic diagram of a time measurement circuit 23b according to a modification. The time measurement circuit 23b includes a buffer circuit 231b, a time setting circuit 234b, an RC delay circuit 235, and an RC delay circuit 236 instead of the OR circuit 231a and the time setting circuit 234b in the time measurement circuit 23a. The time measurement circuit 23b counts the time by a circuit equivalent to the time measurement circuit 23a based on the protection delay time measurement request Spdm having a high level.

The state transition detection circuit according to the modification does not include the OR circuit 267 in the state transition detection circuit 26a, but generates the charge control transition time measurement request Sctm having a high level based on the change in the charge control signal Scc. In addition, the state transition detection circuit according to the modification generates the discharge control transition time measurement request Sdtm having a high level based on the change in the discharge control signal Sdc. The time measurement circuit 23b inputs the charge control transition time measurement request Sctm having a high level to the RC delay circuit 235, and generates the charge control transition time elapse signal Sctp after the predetermined time interval T2. The time measurement circuit 23b inputs the discharge control transition time measurement request Sdtm having a high level to the RC delay circuit 236, and generates the discharge control transition time elapse signal Sdtp after a predetermined time interval T5.

The charge and discharge control circuits 10 and 10a according to the first and second embodiments described above include the discharge control transistor 12 and the charge control transistor 13 having a low-side configuration. That is, the charge and discharge control circuits 10 and 10a have a configuration in which the discharge control transistor 12 and the charge control transistor 13 are connected in series between the negative electrode of the secondary battery 11 (that is, the negative electrode power supply terminal T12) and the external negative electrode terminal T22. However, the charge and discharge control circuit according to the present disclosure is not limited to this configuration. The charge and discharge control circuit may have a high-side configuration in which the discharge control transistor 12 and the charge control transistor 13 are connected in series between the positive electrode of the secondary battery 11 (that is, the positive electrode power supply terminal T11) and the external positive electrode terminal T21.

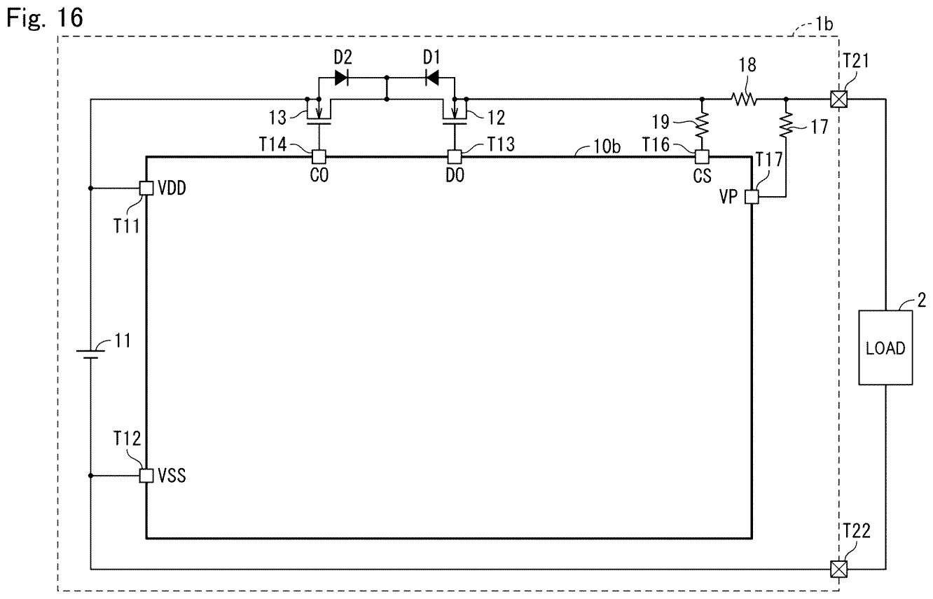

FIG. 16 is a schematic diagram of a battery device 1b according to a modification. The battery device 1b includes a charge and discharge control circuit 10b and resistors 17 to 19 instead of the charge and discharge control circuit 10 and the resistors 14 to 16 in the battery device 1 according to the first embodiment. The charge and discharge control circuit 10b includes an external positive electrode voltage input terminal T17 for monitoring the external positive electrode voltage VP of the external positive electrode terminal T21 instead of the external negative electrode voltage input terminal T15 in the charge and discharge control circuit 10. As described above, in the battery device 1b, the discharge control transistor 12 and the charge control transistor 13 are connected between the positive electrode power supply terminal T11 and the external positive electrode terminal T21. The source of the discharge control transistor 12 is connected to the external positive electrode terminal T21 via the resistor 18.

The external positive electrode voltage input terminal T17 is connected to the external positive electrode terminal T21 and one end of the resistor 18 via the resistor 17. The current detection terminal T16 is connected to the other end of the resistor 18 via the resistor 19. The external positive electrode voltage input terminal T17 is an example of an external voltage detection terminal.

In the charge and discharge control circuit 10b according to the modification, the short-circuit detection circuit generates a short-circuit detection signal based on, for example, the differential voltage between the external positive electrode voltage VP and the current detection voltage CS.

In the external negative electrode voltage input terminal T15 in the low-side configuration and the external positive electrode voltage input terminal T17 in the high-side configuration, the variation of the voltage in the operation of the charge and discharge control circuit is reversed between positive and negative. Thus, for example, the condition that the external negative electrode voltage VM exceeds the predetermined voltage in the low-side configuration can be replaced with a condition that the external positive electrode voltage VP falls below the predetermined voltage in the high-side configuration. The charge and discharge control circuit 10b according to the modification can operate similarly to the charge and discharge control circuits 10 and 10a according to the first and second embodiments described above by replacing the conditions as described above.

In the first embodiment described above, the state transition detection circuit 26 is configured to detect a change in the level of the charge control signal Scc and generate the charge control transition time measurement request Sctm having a high level, but the circuit is not limited to this configuration. The state transition detection circuit may be configured to latch the internal circuit only when, for example, the charge control signal Scc changes from a high level to a low level, or only when the charge control signal Scc changes from a low level to a high level, and generate the charge control transition time measurement request Sctm having a high level. A similar configuration can be applied to the state transition detection circuit 26a that operates based on the change in the level of at least one of the charge control signal Scc or the discharge control signal Sdc.

In the embodiments described above, a plurality of operation modes in which the charge and discharge control circuits 10 and 10a can operate have been described as examples of the protection function in the anomaly state in the charge and discharge control circuits 10 and 10a. However, the plurality of operation modes related to the protection function are not limited to the above operation modes, and may include any operation mode. For example, the plurality of operation modes may include a discharge overcurrent protection mode in which the operation is performed based on detection of overcurrent at the time of discharging, and a charge overcurrent protection mode in which the operation is performed based on detection of overcurrent at the time of charging. For example, the plurality of operation modes may include a high-temperature protection mode in which the operation is performed by detecting that the ambient temperature of the secondary battery 11 is higher than a predetermined threshold, a low-temperature protection mode in which the operation is performed by detecting that the temperature of the secondary battery 11 is lower than a predetermined threshold, and a state control mode in which the discharge control transistor 12 and the charge control transistor 13 are controlled by an external input. For example, a predetermined anomaly detection circuit detects a charging prohibition anomaly state and generates a predetermined anomaly detection signal, and the charge and discharge control circuit can operate in an operation mode based on the anomaly, for example, the charge overcurrent protection mode or the high-temperature protection mode. For example, a predetermined anomaly detection circuit detects a discharging prohibition anomaly state and generates a predetermined anomaly detection signal, and the charge and discharge control circuit can operate in an operation mode based on the anomaly, for example, the discharge overcurrent protection mode or the low-temperature protection mode. When the predetermined control transition time measurement requests Sctm, Sdtm, and Stm are generated, that is, when the circuit is operated in the charge control transition mode or the discharge control transition mode, the charge and discharge control circuit according to the present disclosure can operate so as not to change the level of the charge control signal Scc or the discharge control signal Sdc even when a signal for changing the state of the discharge control transistor 12 or the charge control transistor 13 is generated, such as when an anomaly detection signal related to the operation mode is generated. In addition, when the predetermined control transition time measurement requests Sctm, Sdtm, and Stm are generated due to generation of the anomaly detection signal related to the operation mode, the charge and discharge control circuit according to the present disclosure can similarly operate so as not to change the level of the charge control signal Scc or the discharge control signal Sdc.

In the embodiments described above, the overcharge detection circuit 21 generates the overcharge detection signal Socd having a high level when detecting the charging prohibition anomaly state, but the circuit is not limited to this configuration. The overcharge detection circuit 21 may be configured to generate the overcharge detection signal Socd having a low level when detecting the charging prohibition anomaly state, and the control circuit 20 may be configured to make the protection delay time measurement request Spdm having a high level based on the overcharge detection signal Socd having a low level. Generation of the anomaly detection signal by the overcharge detection circuit 21 may include generation of the overcharge detection signal Socd having a low level by the overcharge detection circuit 21. Similarly, other circuits such as the control circuit 20, the short-circuit detection circuit 22, and the time measurement circuit 23 may be configured to generate a signal having a low level when a predetermined condition is satisfied. The charge control transistor 13 may be configured to be turned on when the control circuit 20 generates the charge control signal Scc having a low level. In this manner, the charge and discharge control circuit according to the present disclosure may be configured to operate based on a signal at a level different from that of the embodiments described above.

In the embodiments described above, the charge and discharge control circuits 10 and 10a are configured to operate in each operation mode based on a predetermined signal, but the charge and discharge control circuits 10 and 10a are not limited to this configuration. The charge and discharge control circuits 10 and 10a may be configured such that the control circuits 20 and 20a operate in each operation mode based on a predetermined signal. For example, at time t22 of the timing chart illustrated in FIG. 14, the control circuit 20a may be configured to transition from the overdischarge protection mode to the normal mode based on the overdischarge recovery delay time elapse signal Sodrdp having a high level, thereby generating the protection delay time measurement request Spdm having a low level. In this manner, in the present disclosure, for example, the control circuit 20 or 20a generating another signal based on a specific signal may include the control circuit 20 or 20a operating in a predetermined operation mode based on the specific signal and generating the other signal based on the operation in the predetermined operation mode.

The charge and discharge control circuit 10, 10a, 10b according to the present disclosure can achieve the following effects.

The charge and discharge control circuit 10, 10a, 10b for preventing malfunction when the switch 12, 13 that controls charging and discharging of the secondary battery 11 is turned on or off includes anomaly detection circuit 21, 22, 22a, 30, control circuit 20, 20a, and state transition detection circuit 26, 26a. The anomaly detection circuit 21, 22, 22a, 30 detects a charging prohibition anomaly state or a discharging prohibition anomaly state to generate anomaly detection signal Socd, Ssd, Sodd. The anomaly detection circuit 21, 22, 22a, 30 detects resolution of the charging prohibition anomaly state or the discharging prohibition anomaly state to stop generation of the anomaly detection signal Socd, Ssd, Sodd. The control circuit 20, 20a generates switch control signal Scc, Sdc having a first value for turning off the switch 12, 13 based on the anomaly detection signal Socd, Ssd, Sodd, or switch control signal Scc, Sdc having a second value for turning on the switch 12, 13 based on the anomaly detection signal Socd, Sodd. The state transition detection circuit 26, 26a generates the first count request signal Stm, Sctm. Sdtm based on the change in the value of the switch control signal Scc, Sdc. The state transition detection circuit 26, 26a stops generation of the first count request signal Stm, Sctm, Sdtm after a predetermined first time interval T2, T5 from occurrence of the first count request signal Stm, Sctm, Sdtm. During the generation of the first count request signal Stm, Sctm, Sdtm, the control circuit 20, 20a holds the switch control signal Scc, Sdc to a value obtained on the occurrence of the first count request signal Stm, Sctm, Sdtm.

According to the configuration, the control circuit 20, 20a performs control such that the level of the switch control signal Scc, Sdc does not change until the predetermined first time interval T2, T5 elapses from the occurrence of change in the level of the switch control signal Scc, Sdc. Thus, the charge and discharge control circuit 10, 10a, 10b can prevent malfunction due to erroneous detection of an anomaly state by the anomaly detection circuit when at least one of the switch 12 or 13 is turned on or off. In addition, because the predetermined first time interval T2, T5 can be predetermined, any first time intervals T2, T5 can be set for each device to which the charge and discharge control circuit 10, 10a, 10b is attached. Thus, because the first time interval T2, T5 can be set to a time interval in which it is necessary to prevent the charge and discharge transistors from changing to an unintended state, the charge and discharge control circuit 10, 10a, 10b can appropriately protect the battery device 1, 1a, 1b.

The charge and discharge control circuit 10, 10a, 10b further includes time measurement circuit 23, 23a that generate a first time interval elapse signal Sctp, Sdtp after the first time interval T2, T5 from the occurrence of the first count request signal Stm, Sctm, Sdtm. The state transition detection circuit stops generation of the first count request signal Stm, Sctm, Sdtm based on the first time interval elapse signal Sctp, Sdtp. According to the configuration, the time measurement circuit 23, 23a can set any first time interval T2, T5. Because the first time interval T2, T5 can be set to a time interval in which it is necessary to prevent the charge and discharge transistors from changing to an unintended state, the charge and discharge control circuit 10, 10a, 10b can appropriately protect the battery device 1, 1a, 1b.

In the charge and discharge control circuit 10, 10a, 10b, the switch includes first switch 13 that controls charging. The anomaly detection signal includes a charging anomaly detection signal Socd generated based on the detection of the charging prohibition anomaly state. The control circuit 20, 20a generates the switch control signal Scc having the first value after a predetermined second time interval T1 based on occurrence of the charging anomaly detection signal Socd, or generate the switch control signal Scc having the second value after a predetermined third time interval based on stopping of generation of the charging anomaly detection signal Socd. According to the configuration, even though erroneous detection of the anomaly state has occurred when the switch control signal Scc has changed based on the detection of the charging prohibition anomaly state, it is possible to prevent an unintended change in the state of at least one of the switch 12 or 13. Thus, the charge and discharge control circuit 10, 10a, 10b can prevent malfunction due to erroneous detection of an anomaly state by the anomaly detection circuit when the switch 13 is turned on or off.

In the charge and discharge control circuit 10, 10a, 10b, the control circuit 20 20a generates the second count request signal Spdm based on the occurrence of the charging anomaly detection signal Socd, and stops generation of the second count request signal Spdm based on the second time interval elapse signal Socdp to generate the switch control signal Scc having the first value. Alternatively, the control circuit 20 20a generates the third count request signal Spdm based on stopping of the charging anomaly detection signal Socd, and stops generation of the third count request signal Spdm based on the third time interval elapse signal to generate the switch control signal Scc having the second value. The time measurement circuit 23, 23a, 23b further generates a second time interval elapse signal Socdp after a second time interval T1 from the occurrence of the second count request signal Spdm, and generates a third time interval elapse signal after a third time interval from the occurrence of the third count request signal Spdm. The control circuit 20, 20a prohibits generating the second count request signal Spdm and the third count request signal Spdm until the first time interval T2 elapses from the occurrence of the first count request signal Stm, Sctm. According to the configuration, the control circuit 20, 20a does not generate the second or third count request signal Spdm until after the first time interval T2 after changing the switch control signal Scc even though the anomaly detection signal is generated. Thus, the switch control signal Scc is not changed based on the anomaly detection signal. Thus, the charge and discharge control circuit 10, 10a, 10b can prevent malfunction due to erroneous detection of an anomaly state by the anomaly detection circuit when the switch 13 is turned on or off.

In the charge and discharge control circuit 10, 10a, 10b, the switch further includes the second switch 12 that controls discharging. The anomaly detection signal includes a discharging anomaly detection signal Sodd generated based on the detection of the discharging prohibition anomaly state. The control circuit 20, 20a further generates a fourth count request signal Spdm based on occurrence of the discharging anomaly detection signal Sodd, and generates a switch control signal Sdc having a first value after a predetermined fourth time interval from occurrence of the fourth count request signal Spdm. Alternatively, the control circuit 20, 20a generates a fifth count request signal Spdm based on stopping of generation of the discharging anomaly detection signal Sodd, and generates the switch control signal Sdc having the second value after a predetermined fifth time interval T4 from occurrence of the fifth count request signal Spdm. The control circuit 20, 20a further prohibits generating the fourth count request signal Spdm or the fifth count request signal Spdm until the first time interval T5 elapses from the occurrence of the first count request signal Stm, Sdtm. According to the configuration, even though erroneous detection of the anomaly state has occurred when the switch control signal Sdc has changed based on the detection of the discharging prohibition anomaly state, it is possible to prevent an unintended change in the state of at least one of the switch 12 or 13. Thus, the charge and discharge control circuit 10, 10a, 10b can prevent malfunction due to erroneous detection of an anomaly state by the anomaly detection circuit when the switch 12 is turned on or off.

In the charge and discharge control circuit 10, 10a, 10b, the switch control signal includes charge control signal Scc for controlling the first switch 13 and the discharge control signal Sdc for controlling the second switch 12. The first time interval is a predetermined sixth time interval T2 in the case where the switch control signal is the charge control signal Scc, and is a predetermined seventh time interval T5 in the case where the switch control signal is the discharge control signal Sdc. The predetermined sixth time interval T2 and the predetermined seventh time interval T5 are different from each other. The state transition detection circuit 26, 26a stops, after the occurrence of the first count request signal Stm, Sctm based on the change in the value of the charge control signal Scc, the generation of the first count request signal Stm, Sctm after the sixth time interval T2 from the occurrence of the first count request signal Stm, Sctm. Alternatively, The state transition detection circuit 26, 26a stops, after the occurrence of the first count request signal Stm, Sdtm based on the change in the value of the discharge control signal Sdc, the generation of the first count request signal Stm, Sdtm after a seventh time interval T5 from the occurrence of the first count request signal Stm, Sdtm. According to the configuration, the charge and discharge control circuit 10, 10a, 10b can prohibit generation of the second to fifth count request signal Spdm for different time intervals for the change in the charge control signal Scc and the change in the discharge control signal Sdc. Thus, the charge and discharge control circuit 10, 10a, 10b can flexibly adjust the predetermined time interval T2 for the change in the charge control signal Scc and the predetermined time interval T5 for the discharge control signal Sdc, and can more appropriately protect the battery device 1, 1a, 1b.

In the charge and discharge control circuit 10, 10a, 10b, the first time interval T2 T5, the second time interval T1, and the third time interval are counted by the same time measurement circuit 23, 23a, 23b that generates the first time interval elapse signal Sctp, Sdtp, the second time interval elapse signal Socdp, and the third time interval elapse signal different from each other. According to the configuration, because the plurality of predetermined time intervals can be counted by the same time measurement circuit 23, 23a, 23b, it is possible to reduce the size as compared with the charge and discharge control circuit including the time measurement circuit for each predetermined time interval. Thus, the charge and discharge control circuit 10, 10a, 10b can protect the battery device 1, 1a, 1b with a simple configuration.

In the charge and discharge control circuit 10, 10a, 10b, the switch includes second switch element 12 that controls discharge. The anomaly detection signal includes a discharging anomaly detection signal Sodd generated based on the detection of the discharging prohibition anomaly state. The control circuit 20, 20a generates the switch control signal Sdc having the first value after a predetermined fourth time interval from occurrence of the discharging anomaly detection signal Sodd, and generates the switch control signal Sdc having the second value after a predetermined fifth time interval T4 from the stop of generation of the discharging anomaly detection signal Sodd. In this manner, the control circuit 20, 20a can operate to turn off the switch 12 based on generation of the discharging anomaly detection signal Sodd and to turn on the switch 12 based on stopping of generation of the discharging anomaly detection signal Sodd. In addition, even though erroneous detection of an anomaly state has occurred when the switch control signal Sdc has changed based on the detection of the discharging prohibition anomaly state, the charge and discharge control circuit 10, 10a, 10b can prevent an unintended change in the state of at least one of the switch 12 or 13. Thus, the charge and discharge control circuit 10, 10a, 10b can prevent malfunction due to erroneous detection of an anomaly state by the anomaly detection circuit when the switch 12 is turned on or off.

The charge and discharge control circuit 10, 10a, 10b further include external voltage detection terminal T15, T17 to be connected to the charger 2 connected to the charge and discharge control circuit 10, 10a, 10b, and a charger connection detection circuit 29 that generates a charger connection detection signal Sed based on the voltage VM, VP of the external voltage detection terminal T15, T17. The switch includes a second switch 12 that controls discharge. The anomaly detection signal includes a discharging anomaly detection signal Ssd generated based on the detection of the discharging prohibition anomaly state. The control circuit 20, 20a generates the switch control signal Sdc having the first value after a predetermined fourth time interval from occurrence of the discharging anomaly detection signal Ssd, and generates the switch control signal Sdc having the second value after a predetermined fifth time interval from occurrence of the charger connection detection signal Scd. In this manner, the control circuit 20, 20a can operate to turn off the switch 12 based on generation of the discharging anomaly detection signal Ssd and tum on the switch 12 based on the charger connection detection signal Scd. In addition, even though erroneous detection of an anomaly state has occurred when the switch control signal Sdc has changed based on the detection of the discharging prohibition anomaly state, the charge and discharge control circuit 10, 10a, 10b can prevent an unintended change in the state of at least one of the switch 12 or 13. Thus, the charge and discharge control circuit 10, 10a, 10b can prevent malfunction due to erroneous detection of an anomaly state by the anomaly detection circuit when the switch 12 is turned on or off.

In the charge and discharge control circuit 10, 10a, 10b, the anomaly detection circuit includes at least one of an overcharge detection circuit 21 that detects overcharge of the secondary battery 11 or an overdischarge detection circuit 30 that detects overdischarge of the secondary battery 11. According to the configuration, the control circuit 20, 20a performs control such that the level of the switch control signal Scc, Sdc does not change until the predetermined first time interval T2, T5 elapses from the occurrence or stop of the anomaly detection signal Socd, Sodd for the anomaly state related to overcharge or the anomaly state related to overdischarge. Thus, the charge and discharge control circuit 10, 10a, 10b can prevent malfunction due to erroneous detection of an anomaly state by the anomaly detection circuit when the switch 12 or 13 is turned on or off due to detection of an anomaly state related to overdischarge or overcharge or recovery from the anomaly state.

The charge and discharge control circuit 10, 10a, 10b further includes the external voltage detection terminal T15, T17 to be connected, via the resistor, to the positive electrode or the negative electrode of the load 2 to be connected to the charge and discharge control circuit 10, 10a, 10b. The external voltage detection terminal T15, T17 has the external voltage VM, VP corresponding to the voltage of the positive electrode or the negative electrode. The anomaly detection circuit 30 detects a charging prohibition anomaly state or a discharging prohibition anomaly state based on the change in the external voltage VM, VP when the switch 12 or 13 is turned on or off. According to the configuration, in the charge and discharge control circuit 10, 10a, 10b, the external voltage VM, VP may vary when the switch 12 or 13 is turned on or off. Because the charge and discharge control circuit 10, 10a, 10b is configured to detect a predetermined anomaly state based on variation in the external voltage VM, VP, when the variation occurs in the external voltage VM, VP when the switch 12 or 13 is turned on or off, the anomaly state may be erroneously detected. In the charge and discharge control circuit 10, 10a, 10b according to the present disclosure, when the level of the switch control signal Scc or Sdc changes, the control circuit 20, 20a performs control so that the level of the switch control signal Scc, Sdc does not change until after the first time interval T2, T5 from the occurrence of the change. Thus, the charge and discharge control circuit 10, 10a, 10b can prevent malfunction of the charge and discharge control circuit 10, 10a, 10b even when the variation of the external voltage VM, VP occurs when the switch 12 or 13 is turned on or off, and erroneous detection of an anomaly state by the anomaly detection circuit occurs based on the variation.

In the charge and discharge control circuit 10, 10a, 10b, the first time interval T2, T5 is measured by the RC delay circuit 235, 236. According to the configuration, the first time interval T2, T5 can be measured with a simple configuration.

The battery device 1, 1a, 1b includes the charge and discharge control circuit 10, 10a, 10b described above, the secondary battery 11, the first switch 13 that controls charging of the secondary battery 11, and the second switch 12 that controls discharging of the secondary battery 11. According to the configuration, it is possible to prevent malfunction that occurs when the switch that controls charging and discharging of the secondary battery is turned on or off.

A charge and discharge control method for preventing malfunction when the switch 12, 13 for controlling charging and discharging of the secondary battery 11 is turned on or off includes the following processing. The charge and discharge control method includes, by the anomaly detection circuit 21, 22, 22a, 30, detecting the charging prohibition anomaly state or the discharging prohibition anomaly state to generate the anomaly detection signal Socd, Ssd, Sodd, and detecting resolution of the charging prohibition anomaly state or the discharging prohibition anomaly state to stop generation of the anomaly detection signal Socd, Ssd, Sodd. The charge and discharge control method includes generating, by the control circuit 20, 20a, switch control signal Sdc, Scc having a first value for turning off the switch 12, 13 based on the anomaly detection signal Socd, Ssd. Sodd, or switch control signal Sdc, Scc having a second value for turning on the switch 12, 13 based on the anomaly detection signal Socd, Sodd. The charge and discharge control method includes, by the state transition detection circuit 26, 26a, generating the first count request signal Stm, Sctm, Sdtm based on a change in the value of the switch control signal Sdc, Scc, and stopping generation of the first count request signal Stm, Sctm, Sdtm after predetermined first time interval T2, T5 from occurrence of the first count request signal Stm, Sctm, Sdtm. During the generation of the first count request signal Stm, Sctm, Sdtm, the control circuit 20, 20a holds the switch control signal Sdc, Scc to a value obtained on the occurrence of the first count request signal Stm, Sctm, Sdtm.

By operating in this manner, the control circuit 20, 20a performs control such that the level of the switch control signal Scc, Sdc does not change until the predetermined first time interval T2, T5 elapses from the occurrence of change in the level of the switch control signal Scc, Sdc. Thus, according to the charge and discharge control method, it is possible to prevent malfunction due to erroneous detection of an anomaly state by the anomaly detection circuit when the switch 12, 13 is turned on or off.

### Summary of Aspects

As apparent from the above description, the present disclosure includes the following aspects. In the following, reference numerals are given in parentheses only to clearly indicate the correspondence with the embodiments.

(Aspect 1) A charge and discharge control circuit (10, 10a, 10b) according to the present disclosure is a charge and discharge control circuit that prevents malfunction when a switch (12, 13) that controls charging and discharging of a secondary battery (11) is turned on or off, the charge and discharge control circuit (10, 10a, 10b) including:
an anomaly detection circuit (21, 22, 22a, 30) detecting a charging prohibition anomaly state or a discharging prohibition anomaly state to generate an anomaly detection signal (Socd, Ssd, Sodd), and detecting resolution of the charging prohibition anomaly state or the discharging prohibition anomaly state to stop generation of the anomaly detection signal;
a control circuit (20, 20a) configured to generate a switch control signal (Sdc, Scc) having a first value for turning off the switch or the switch control signal having a second value for turning on the switch based on the anomaly detection signal; and
a state transition detection circuit (26, 26a) generating a first count request signal (Stm, Sctm, Sdtm) based on a change in a value of the switch control signal and stopping generation of the first count request signal after a first time interval (T2, T5) from occurrence of the first count request signal,
wherein, during the generation of the first count request signal, the control circuit holds the switch control signal to a value obtained on the occurrence of the first count request signal.

(Aspect 2) The charge and discharge control circuit (10, 10a, 10b) according to aspect 1 further includes a time measurement circuit (23, 23a, 23b) that generates a first time interval elapse signal (Sctp, Sdtp) after the first time interval (T2, T5) from the occurrence of the first count request signal (Stm, Sctm, Sdtm),
wherein the state transition detection circuit (26, 26a) stops the generation of the first count request signal based on the first time interval elapse signal.

(Aspect 3) In the charge and discharge control circuit (10, 10a, 10b) according to aspect 2,
the switch includes a first switch (13) controlling charging,
the anomaly detection signal includes a charging anomaly detection signal (Socd) generated based on detection of the charging prohibition anomaly state, and
the control circuit (20, 20a) is further configured to:
   generate the switch control signal (Scc) having the first value after a second time interval (T1) based on occurrence of the charging anomaly detection signal; or
   generate the switch control signal having the second value after a third time interval based on stopping of generation of the charging anomaly detection signal.

(Aspect 4) In the charge and discharge control circuit (10, 10a, 10b) according to aspect 3,
the control circuit (20, 20a) is further configured to:
   generate a second count request signal (Spdm) based on the occurrence of the charging anomaly detection signal (Socd), and stop generation of the second count request signal based on a second time interval elapse signal (Socdp) to generate the switch control signal (Scc) having the first value; or
   generate a third count request signal (Spdm) based on stopping of the charging anomaly detection signal, and stop generation of the third count request signal based on a third time interval elapse signal to generate the switch control signal having the second value,
the time measurement circuit (23, 23a, 23b) further generates the second time interval elapse signal after the second time interval (T1) from the occurrence of the second count request signal, or generates the third time interval elapse signal after the third time interval from the occurrence of the third count request signal, and
the control circuit is further configured to prohibit generating the second count request signal or the third count request signal until the first time interval (T2) elapses from the occurrence of the first count request signal (Stm, Sctm).

(Aspect 5) In the charge and discharge control circuit (10, 10a, 10b) according to aspect 4,
the switch further includes a second switch (12) controlling discharging,
the anomaly detection signal includes a discharging anomaly detection signal (Sodd) generated based on detection of the discharging prohibition anomaly state,
the control circuit (20, 20a) is further configured to:
   generate a fourth count request signal (Spdm) based on occurrence of the discharging anomaly detection signal, and generate the switch control signal (Sdc) having the first value after a fourth time interval from occurrence of the fourth count request signal; or
   generate a fifth count request signal (Spdm) based on stopping of generation of the discharging anomaly detection signal, and generate the switch control signal having the second value after a fifth time interval (T4) from occurrence of the fifth count request signal, and
the control circuit is further configured to prohibit generating the fourth count request signal or the fifth count request signal until the first time interval (T5) elapses from the occurrence of the first count request signal (Stm, Sdtm).

(Aspect 6) In the charge and discharge control circuit (10, 10a, 10b) according to aspect 5,
the switch control signal includes a charge control signal (Scc) for controlling the first switch (13) and a discharge control signal (Sdc) for controlling the second switch (12),
the first time interval is a sixth time interval (T2) in the case where the switch control signal is the charge control signal, and is a seventh time interval (T5) in the case where the switch control signal is the discharge control signal, the sixth time interval and the seventh time interval being different from each other, and
the state transition detection circuit (26, 26a) is further configured to:
   stop, after the occurrence of the first count request signal (Stm, Sctm) based on a change in a value of the charge control signal, the generation of the first count request signal after the sixth time interval from the occurrence of the first count request signal, or
   stop, after the occurrence of the first count request signal (Stm, Sdtm) based on a change in a value of the discharge control signal, the generation of the first count request signal after the seventh time interval from the occurrence of the first count request signal.

(Aspect 7) In the charge and discharge control circuit (10, 10a, 10b) according to aspect 4 or 5, the first time interval (T2, T5), the second time interval (T1), and the third time interval are counted by the same time measurement circuit (23, 23a, 23b) generating the first time interval elapse signal (Sctp, Sdtp), the second time interval elapse signal (Socdp), and the third time interval elapse signal different from each other.

(Aspect 8) In the charge and discharge control circuit (10, 10a, 10b) according to aspect 2,
the switch includes a second switch (12) controlling discharging,
the anomaly detection signal includes a discharging anomaly detection signal (Sodd) generated based on detection of the discharging prohibition anomaly state, and
the control circuit (20, 20a) is configured to:
   generate the switch control signal (Sdc) having the first value after a fourth time interval from occurrence of the discharging anomaly detection signal, and
   generate the switch control signal having the second value after a fifth time interval (T4) from stopping of generation of the discharging anomaly detection signal.

(Aspect 9) In the charge and discharge control circuit (10, 10a, 10b) according to aspect 2 further includes:
an external voltage detection terminal (T15, T17) to be connected to a charger (2) to be connected to the charge and discharge control circuit; and
a charger connection detection circuit (29) generating a charger connection detection signal (Scd) based on a voltage (VM, VP) of the external voltage detection terminal,
wherein the switch includes a second switch (12) controlling discharging,
the anomaly detection signal includes a discharging anomaly detection signal (Ssd) generated based on detection of the discharging prohibition anomaly state, and
the control circuit (20, 20a) is further configured to:
   generate the switch control signal (Sdc) having the first value after a fourth time interval from occurrence of the discharging anomaly detection signal, and
   generate the switch control signal having the second value after a fifth time interval from occurrence of the charger connection detection signal.

(Aspect 10) The charge and discharge control circuit (10, 10a, 10b) according to any one of aspect 1 to aspect 8 further includes an external voltage detection terminal (T15, T17) to be connected, via a resistor, to a positive electrode or a negative electrode of a load (2) to be connected to the charge and discharge control circuit,
wherein the external voltage detection terminal has an external voltage (VM, VP) corresponding to a voltage of the positive electrode or the negative electrode, and
the anomaly detection circuit (30) detects the charging prohibition anomaly state or the discharging prohibition anomaly state based on a change in the external voltage upon turning the switch (12, 13) on or off.

(Aspect 11) In the charge and discharge control circuit (10, 10a, 10b) according to any one of aspect 1 to aspect 10, the anomaly detection circuit includes at least one of an overcharge detection circuit (21) detecting overcharge of the secondary battery (11) or an overdischarge detection circuit (30) detecting overdischarge of the secondary battery.

(Aspect 12) In the charge and discharge control circuit (10, 10a, 10b) according to any one of aspect 1 to aspect 11, the first time interval (T2, T5) is measured by an RC delay circuit (235, 236).

(Aspect 13) A battery device (1, 1a, 1b) according to the present disclosure includes:
the charge and discharge control circuit (10, 10a, 10b) according to any one of aspect 1 to aspect 12;
a secondary battery (11);
a first switch (13) controlling charging of the secondary battery; and
a second switch (12) controlling discharging of the secondary battery.

(Aspect 14) A charge and discharge control method according to the present disclosure is a charge and discharge control method for preventing malfunction when a switch (12, 13) controlling charging and discharging of a secondary battery (11) is turned on or off, the method including:
detecting, by an anomaly detection circuit (21, 22, 22a, 30), a charging prohibition anomaly state or a discharging prohibition anomaly state to generate an anomaly detection signal (Socd, Ssd, Sodd), and detecting resolution of the charging prohibition anomaly state or the discharging prohibition anomaly state to stop generation of the anomaly detection signal;
generating, by a control circuit (20, 20a), a switch control signal (Sdc, Scc) having a first value for turning off the switch or the switch control signal having a second value for turning on the switch based on the anomaly detection signal; and
generating, by a state transition detection circuit (26, 26a), a first count request signal (Stm, Sctm, Sdtm) based on a change in a value of the switch control signal, and stopping generation of the first count request signal after a first time interval (T2, T5) from occurrence of the first count request signal,
wherein, during the generation of the first count request signal, the control circuit holds the switch control signal to a value obtained on the occurrence of the first count request signal.

In the present specification, the terms “first”, “second”, and the like are only used for description, and should not be understood as clearly indicating or implying relative importance or a rank of a technical feature. Features limited to “first” and “second” are intended to clearly indicate or imply the inclusion of one or more such features.

According to the present disclosure, it is possible to provide a charge and discharge control circuit, a charge and discharge control method, and a battery device that suppress malfunction when a switch that controls charging and discharging of a secondary battery is turned on or off, as compared with the conventional technique. Thus, the present disclosure can be suitably used in this type of industrial field.

What is claimed is:

1. A charge and discharge control circuit for preventing malfunction when a switch that controls charging and discharging of a secondary battery is turned on or off, the charge and discharge control circuit comprising:
an anomaly detection circuit detecting a charging prohibition anomaly state or a discharging prohibition anomaly state to generate an anomaly detection signal, and detecting resolution of the charging prohibition anomaly state or the discharging prohibition anomaly state to stop generation of the anomaly detection signal;
a control circuit configured to generate a switch control signal having a first value for turning off the switch or the switch control signal having a second value for turning on the switch based on the anomaly detection signal; and
a state transition detection circuit generating a first count request signal based on a change in a value of the switch control signal and stopping generation of the first count request signal after a first time interval from occurrence of the first count request signal,
wherein, during the generation of the first count request signal, the control circuit holds the switch control signal to a value obtained on the occurrence of the first count request signal.

2. The charge and discharge control circuit as claimed in claim 1, further comprising a time measurement circuit that generates a first time interval elapse signal after the first time interval from the occurrence of the first count request signal,
wherein the state transition detection circuit stops the generation of the first count request signal based on the first time interval elapse signal.

3. The charge and discharge control circuit as claimed in claim 2, wherein the switch includes a first switch controlling charging,
the anomaly detection signal includes a charging anomaly detection signal generated based on detection of the charging prohibition anomaly state, and
the control circuit is further configured to:
generate the switch control signal having the first value after a second time interval based on occurrence of the charging anomaly detection signal; or
generate the switch control signal having the second value after a third time interval based on stopping of generation of the charging anomaly detection signal.

4. The charge and discharge control circuit as claimed in claim 3, wherein the control circuit is further configured to:
generate a second count request signal based on the occurrence of the charging anomaly detection signal, and stop generation of the second count request signal based on a second time interval elapse signal to generate the switch control signal having the first value; or
generate a third count request signal based on stopping of the charging anomaly detection signal, and stop generation of the third count request signal based on a third time interval elapse signal to generate the switch control signal having the second value,
the time measurement circuit further generates the second time interval elapse signal after the second time interval from the occurrence of the second count request signal, or generates the third time interval elapse signal after the third time interval from the occurrence of the third count request signal, and
the control circuit is further configured to prohibit generating the second count request signal or the third count request signal until the first time interval elapses from the occurrence of the first count request signal.

5. The charge and discharge control circuit as claimed in claim 4, wherein the switch further includes a second switch controlling discharging,
the anomaly detection signal includes a discharging anomaly detection signal generated based on detection of the discharging prohibition anomaly state,
the control circuit is further configured to:
generate a fourth count request signal based on occurrence of the discharging anomaly detection signal, and generate the switch control signal having the first value after a fourth time interval from occurrence of the fourth count request signal; or
generate a fifth count request signal based on stopping of generation of the discharging anomaly detection signal, and generate the switch control signal having the second value after a fifth time interval from occurrence of the fifth count request signal, and
the control circuit is further configured to prohibit generating the fourth count request signal or the fifth count request signal until the first time interval elapses from the occurrence of the first count request signal.

6. The charge and discharge control circuit as claimed in claim 5, wherein the switch control signal includes a charge control signal for controlling the first switch and a discharge control signal for controlling the second switch,
the first time interval is a sixth time interval in the case where the switch control signal is the charge control signal, and is a seventh time interval in the case where the switch control signal is the discharge control signal, the sixth time interval and the seventh time interval being different from each other, and
the state transition detection circuit is further configured to:
stop, after the occurrence of the first count request signal based on a change in a value of the charge control signal, the generation of the first count request signal after the sixth time interval from the occurrence of the first count request signal, or
stop, after the occurrence of the first count request signal based on a change in a value of the discharge control signal, the generation of the first count request signal after the seventh time interval from the occurrence of the first count request signal.

7. The charge and discharge control circuit as claimed in claim 4, wherein the first time interval, the second time interval, and the third time interval are counted by the same time measurement circuit generating the first time interval elapse signal, the second time interval elapse signal, and the third time interval elapse signal different from each other.

8. The charge and discharge control circuit as claimed in claim 2, wherein the switch includes a second switch controlling discharging,
the anomaly detection signal includes a discharging anomaly detection signal generated based on detection of the discharging prohibition anomaly state, and
the control circuit is further configured to:
generate the switch control signal having the first value after a fourth time interval from occurrence of the discharging anomaly detection signal, and
generate the switch control signal having the second value after a fifth time interval from stopping of generation of the discharging anomaly detection signal.

9. The charge and discharge control circuit as claimed in claim 2, further comprising:
an external voltage detection terminal to be connected to a charger to be connected to the charge and discharge control circuit; and
a charger connection detection circuit generating a charger connection detection signal based on a voltage of the external voltage detection terminal,
wherein the switch includes a second switch controlling discharging,
the anomaly detection signal includes a discharging anomaly detection signal generated based on detection of the discharging prohibition anomaly state, and
the control circuit is further configured to:
generate the switch control signal having the first value after a fourth time interval from occurrence of the discharging anomaly detection signal, and
generate the switch control signal having the second value after a fifth time interval from occurrence of the charger connection detection signal.

10. The charge and discharge control circuit as claimed in claim 1, further comprising an external voltage detection terminal to be connected, via a resistor, to a positive electrode or a negative electrode of a load to be connected to the charge and discharge control circuit,
wherein the external voltage detection terminal has an external voltage corresponding to a voltage of the positive electrode or the negative electrode, and
the anomaly detection circuit detects the charging prohibition anomaly state or the discharging prohibition anomaly state based on a change in the external voltage upon turning the switch on or off.

11. The charge and discharge control circuit as claimed in claim 1, wherein the anomaly detection circuit includes at least one of an overcharge detection circuit detecting overcharge of the secondary battery or an overdischarge detection circuit detecting overdischarge of the secondary battery.

12. The charge and discharge control circuit as claimed in claim 1, wherein the first time interval is measured by an RC delay circuit.

13. A battery device comprising:
the charge and discharge control circuit as claimed in claim 1;
a secondary battery;
a first switch element controlling charging of the secondary battery; and
a second switch element controlling discharging of the secondary battery.

14. A charge and discharge control method for preventing malfunction when a switch controlling charging and discharging of a secondary battery is turned on or off, the method comprising:
detecting, by an anomaly detection circuit, a charging prohibition anomaly state or a discharging prohibition anomaly state to generate an anomaly detection signal, and detecting resolution of the charging prohibition anomaly state or the discharging prohibition anomaly state to stop generation of the anomaly detection signal;
generating, by a control circuit, a switch control signal having a first value for turning off the switch or the switch control signal having a second value for turning on the switch based on the anomaly detection signal; and
generating, by a state transition detection circuit, a first count request signal based on a change in a value of the switch control signal, and stopping generation of the first count request signal after a first time interval from occurrence of the first count request signal,
wherein, during the generation of the first count request signal, the control circuit holds the switch control signal to a value obtained on the occurrence of the first count request signal.
